(19) United States
(12) Patent Application Publication
(10) Pub. No.: US 2025/0360401 A1
(43) Pub. Date: Nov. 27, 2025

(54) RUNNING METHOD AND APPARATUS FOR VIRTUAL WORLD

(71) Applicant: TENCENT TECHNOLOGY (SHENZHEN) COMPANY LIMITED, Shenzhen (CN)

(72) Inventor: Boyuan PAN, Shenzhen (CN)

(73) Assignee: TENCENT TECHNOLOGY (SHENZHEN) COMPANY LIMITED, Shenzhen, GD (CN)

(21) Appl. No.: 19/292,639

(22) Filed: Aug. 6, 2025

Related U.S. Application Data
(63) Continuation of application No. PCT/CN2024/088208, filed on Apr. 17, 2024.

(30) Foreign Application Priority Data
Jun. 15, 2023 (CN) 202310712728.6

(51) Int. Cl. A63F 13/352

(52) U.S. Cl. CPC A63F 13/352; A63F 2300/513; A63F 2300/8082

(57) ABSTRACT

According to a method for running a virtual world in a virtual scene application, an event generation instruction is received, the event generation instruction instructs a generation of a first virtual event by a first virtual element with a consumption of at least a portion of first element energy of the first virtual element, the first virtual element is one of a plurality of virtual elements that form the virtual world, and the plurality of virtual elements in the virtual world implement energy interaction through virtual events. Based on the event generation instruction, element sub-energy is consumed from the first element energy, the element sub-energy is used for completing the first virtual event. The first virtual event is generated based on the consuming of the element sub-energy from the first element energy of the first virtual element. Apparatus and non-transitory computer-readable storage medium counterpart embodiments are also contemplated.

### RELATED APPLICATIONS

The present application is a continuation of International Application No. PCT/CN2024/088208, filed on Apr. 17, 2024, which claims priority to Chinese Patent Application No. 202310712728.6, filed on Jun. 15, 2023. The entire disclosures of the prior applications are hereby incorporated by reference.

### FIELD OF THE TECHNOLOGY

Embodiments of this application relate to the field of computer technologies, including a running method and apparatus for a virtual world, a device, a storage medium, and a program product.

### BACKGROUND OF THE DISCLOSURE

With the improvement of cultural and entertainment living standards, people have increasingly high life experience and requirements on a virtual scene. As a representation manner of the virtual scene, a game becomes a channel for many people to release pressure. Currently, in a game application, a player participates in different games in a form such as executing various game tasks in a virtual world or performing virtual battles with virtual objects controlled by different players.

In a related technology, in a network game under a background of a virtual world, deployment of the virtual world is usually controlled by a server, and the server coordinates, based on an instruction transmitted by a terminal corresponding to a player and in a manner of delivering a computing resource, a game behavior indicated by the instruction.

However, computing resources corresponding to the server are limited. When the server receives instructions transmitted by a large quantity of terminals and delivers a large quantity of computing resources for the virtual world to run, a problem of computing crashing easily occurs. Consequently, computing power consumption of the virtual world cannot be well controlled. Not only use experience of participating in a game by a player is greatly reduced, but also a huge computing load is increased to the server, and computing efficiency is affected.

### SUMMARY

Embodiments of this disclosure provide a running method and apparatus for a virtual world, a device, a storage medium, and a program product, so as to keep conservation of energy in a virtual world, avoid problems of complex processing of various events by only a server and a large quantity of processing, thereby greatly improving stability of a game. Technical solutions are as follows.

Some aspects of the disclosure provide a method for running a virtual world in a virtual scene application. In some examples, an event generation instruction is received, the event generation instruction instructs a generation of a first virtual event by a first virtual element with a consumption of at least a portion of first element energy of the first virtual element, the first virtual element is one of a plurality of virtual elements that form the virtual world, and the plurality of virtual elements in the virtual world implement energy interaction through virtual events. Based on the event generation instruction, element sub-energy is consumed from the first element energy, the element sub-energy is used for completing the first virtual event. The first virtual event is generated based on the consuming of the element sub-energy from the first element energy of the first virtual element.

Some aspects of the disclosure provide an apparatus that includes processing circuitry configured to perform the method for running the virtual world in the virtual scene application.

Some aspects of the disclosure also provide a non-transitory computer-readable storage medium storing instructions which when executed by at least one processor cause the at least one processor to perform the method for running the virtual world in the virtual scene application.

According to an aspect, a running method for a virtual world is provided, performed by a computer device and including: receiving an event generation instruction for a first virtual element, the event generation instruction being configured for consuming first element energy of the first virtual element and generating a virtual event, the first virtual element being an element forming the virtual world, the virtual event being an event unit running in the virtual world, and a virtual element in the virtual world implementing energy interaction through the virtual event; consuming, based on the event generation instruction, element sub-energy that is in the first element energy and that is required for completing the virtual event; and generating the virtual event based on the element sub-energy.

According to another aspect, a running apparatus for a virtual world is provided, including: a receiving module, configured to receive an event generation instruction for a first virtual element, the event generation instruction being configured for consuming first element energy of the first virtual element and generating a virtual event, the first virtual element being an element forming the virtual world, the virtual event being an event unit running in the virtual world, and a virtual element in the virtual world implementing energy interaction through the virtual event; a consumption module, configured to consume, based on the event generation instruction, element sub-energy that is in the first element energy and that is required for completing the virtual event; and a generation module, configured to generate the virtual event based on the element sub-energy.

According to another aspect, a computer device is provided, including a processor (an example of processing circuitry) and a memory, the memory having at least one instruction, at least one segment of program, a code set, or an instruction set stored therein, and the at least one instruction, the at least one segment of program, the code set, or the instruction set being loaded and executed by the processor to implement the running method for a virtual world according to any one of the foregoing embodiments of this disclosure.

According to another aspect, a computer-readable storage medium (e.g., non-transitory computer-readable storage medium) is provided, having at least one instruction, at least one segment of program, a code set, or an instruction set stored therein, the at least one instruction, the at least one segment of program, the code set, or the instruction set being loaded and executed by a processor to implement the running method for a virtual world according to any one of the foregoing embodiments of this disclosure.

According to another aspect, a computer program product or a computer program is provided, the computer program product or the computer program including computer instructions, and the computer instructions being stored in a computer-readable storage medium. A processor of a computer device reads the computer instructions from the computer-readable storage medium and executes the computer instructions, to enable the computer device to perform the running method for a virtual world according to any one of the foregoing embodiments.

The technical solutions provided in the embodiments of this disclosure produce at least the following beneficial effects:
receiving an event generation instruction for a first virtual element, and consuming, based on the event generation instruction, element sub-energy that is in first element energy and that is required for completing a virtual event, to generate the virtual event based on the element sub-energy. By converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

### BRIEF DESCRIPTION OF THE DRAWINGS

FIG. 1 is a structural block diagram of an electronic device according to an embodiment of this disclosure.

FIG. 2 is a schematic diagram of running a virtual world by a server according to an embodiment of this disclosure.

FIG. 3 is a flowchart of a running method for a virtual world according to an embodiment of this disclosure.

FIG. 4 is a flowchart of a running method for a virtual world according to another embodiment of this disclosure.

FIG. 5 is a schematic diagram of generating a virtual event by a virtual element according to an embodiment of this disclosure.

FIG. 6 is a schematic diagram of a structural framework of a zone server and a computing unit according to an embodiment of this disclosure.

FIG. 7 is a schematic diagram of conversion between a virtual element and a virtual event according to an embodiment of this disclosure.

FIG. 8 is a flowchart of a running method for a virtual world according to still another embodiment of this disclosure.

FIG. 9 is a schematic diagram of applying a virtual event to a virtual element according to an embodiment of this disclosure.

FIG. 10 is a schematic diagram of a component change of a virtual element according to an embodiment of this disclosure.

FIG. 11 is a schematic transfer diagram of implementing a virtual event as a unidirectional transfer event according to an embodiment of this disclosure.

FIG. 12 is a schematic transfer diagram of implementing a virtual event as a spread event according to an embodiment of this disclosure.

FIG. 13 is a schematic diagram of sub-event energy superposition according to an embodiment of this disclosure.

FIG. 14 is a schematic diagram of event interaction according to an embodiment of this disclosure.

FIG. 15 is a schematic diagram of a virtual event crossing a zone server once according to an embodiment of this disclosure.

FIG. 16 is a schematic diagram of a virtual event continuously crossing a zone server according to an embodiment of this disclosure.

FIG. 17 is a structural block diagram of a running apparatus for a virtual world according to an embodiment of this disclosure.

FIG. 18 is a structural block diagram of a running apparatus for a virtual world according to another embodiment of this disclosure.

FIG. 19 is a schematic structural diagram of a server according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Game: is referred to as a network game or an online game and is a multi-player online game using the Internet as a transmission medium and a server as a processing terminal. The game provided in embodiments derives from the special theory of relativity in modern physics, and abandons the game world view in a related technology. A basic principle of the game world view of the embodiments is as follows:
A time relativity and a local inertial reference system: In a related technology, each server (referred to as a zone server in the embodiments) of a game has a global clock (referred to as a virtual time zone in the embodiments), and each zone server needs to keep the clock synchronous, that is, similar to absolute time in classic mechanics. However, in a new game world view, a global uniform clock does not need to be maintained, and only each independent zone server in the game needs to use the server as a local inertial reference system to maintain its own clock. For example, a zone server 1 maintains a clock 1 thereof. The clock 1 may be set to a 24-hour format. A zone server 2 maintains a clock 2 thereof, and the clock 2 is set to a 48-hour format. The clock 1 and the clock 2 are different clocks.
The principle of the constancy of the speed of light: In a related technology, time of information transfer is processed as a delay, and is not processed as a process of a game, and it is assumed in game logic that a speed of information transfer is unlimited. However, the special theory of relativity indicates that a light speed has an upper limit, that is, the speed of information transfer is limited. In a new game world view, an information transfer process is also used as a part of a game. For example, if a player crosses from the zone server 1 to the zone server 2, the cross process is also used as a part of the game.

Virtual world: is a virtual world displayed or provided by a client corresponding to a game provided in the embodiments during running. The virtual world may be a simulated environment of a real world, or may be a semi-simulated and semi-fictional environment, or may be an entirely fictional environment. The virtual world may be any one of a two-dimensional virtual world, a 2.5-dimensional virtual world, and a three-dimensional virtual world.

Virtual object: refers to a movable object in a virtual environment. The movable object may be at least one of a virtual person, a virtual animal, or a cartoon person. In some embodiments, when the virtual environment is the three-dimensional virtual environment, the virtual object may be a three-dimensional virtual model. Each virtual object has a shape and a volume in the virtual environment, and occupies a part of space in the three-dimensional virtual environment. In some embodiments, the virtual object is a three-dimensional character constructed based on a three-dimensional human skeleton technology. The virtual object wears different skins to implement different appearances. In some implementations, the virtual object may alternatively be implemented by using a 2.5-dimensional or two-dimensional model, which is not limited in the embodiments of this disclosure.

Virtual element: refers to various elements appearing in the virtual world, which are configured for constituting the entire virtual world. The virtual elements include a land block, a lake, a sky, various virtual animals, various virtual plants, various virtual buildings, various virtual props, and the like. A virtual object controlled by a player also belongs to one of virtual elements.

Zone server: refers to a regional server, or referred to as a server or a node. One zone server is carried by one server or one server cluster. In the embodiments, a server for deploying a virtual world includes at least two zone servers. The zone servers are not directly connected to each other, but are logically connected to each other by using a message transit node (or referred to as an information transfer node). Each zone server can transfer information only to another zone server that is logically connected to the server, but cannot transfer information to another zone server that is not logically connected to the server.

In an example, a virtual world of an entire game is considered as a ball (references may be made to a shape of a soccer ball), and a server for deploying the virtual world includes at least two zone servers. A sub-virtual world (references may be made to each pentagonal region on the soccer ball) corresponding to each zone server is distributed on a surface of the virtual world. Each zone server extends outward, and is communicatively connected to a limited quantity of other zone servers by using a message transit node. Each zone server or the message transit node has an information transfer path to N zone servers close to a boundary of the zone server. That is, there is a signal line for connection in the physical world, and information can be received and transmitted for each other.

The server in this disclosure may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. In addition, the terminal in this disclosure may be a smartphone, a tablet computer, a notebook computer, a desktop computer, a smart speaker, a smartwatch, or the like, but is not limited thereto. The terminal and the server may be directly or indirectly connected in a wired or wireless communication manner, which is not limited in this disclosure.

Event (or referred to as virtual event): is a basic unit for running a virtual world of an entire game in the embodiments. By analogy, for descriptions of an event in the theory of relativity, because of time relativity in the embodiments, it cannot be said that an event happens at a specific place, but can only be said that an event happens at a specific time in an inertial reference system. That is, an event permanently occurs at a selected [x, y, z, t], where x, y, and z are values in a horizontal coordinate, a vertical coordinate, and a depth coordinate direction in an inertial reference system, and t is a time point in the inertial reference system. Similarly, an event in a virtual world in the embodiments is also described by using an event attribute (what event, represented as what) of the event, a zone server in which the event is located (which inertial reference system, represented as which), a logical location in the zone server (a spatial location in the selected inertial reference system, represented as where), and a generation moment in the zone server (a generation time in the selected inertial reference system, represented as when). Therefore, an event description vector corresponding to the event in the embodiments needs to include at least the foregoing four types of information, and at least the following event description vector is required for description: [what, which, where, when].

Similarly, a virtual element in the game in the embodiments may also be abstracted as an event, which virtual element, located in which zone server, a logical location in the zone server, and a generation moment in the zone server. The only difference from the event is that the virtual element is finally rendered in a virtual world of the game in the embodiments, and can be seen by a user. In the embodiments, the event and the virtual element can be mutually converted and interact with each other. The event may generate a virtual element, and the virtual element may also generate an event. This is similar to a relationship between mass and energy in modern physics. The event is more like energy, and the virtual element is more like mass. In some embodiments, the event corresponds to at least one of virtual energy and virtual mass.

Unidirectional transfer event: is one type of the event in the embodiments and is an event in which a single propagation direction and a termination condition are set. The unidirectional transfer event has virtual energy and virtual mass, consumption of the virtual energy thereof is related to a propagation situation of the virtual event (which is described in detail below), and the virtual mass keeps unchanged. When a local zone server simultaneously computes the same unidirectional transfer event transferred by different zone servers into the local zone server, corresponding virtual energy of the unidirectional transfer event in the local zone server may be accumulated. In some embodiments, the termination condition of the unidirectional transfer event includes: at least one of: a specified propagation quantity is reached, virtual energy being less than an energy threshold, an event reaching a specified zone server, and there is no legal propagation direction for continuing propagation. For example, the unidirectional transfer event may be: a cross-zone server crossing event in which a player crosses from a zone server to another zone server, a same-zone server crossing event in which a player crosses from a computing unit in a zone server to another computing unit, a cross-zone server flight event in which a virtual prop crosses from a zone server to another zone server by flying, and a same-zone server flight event in which a virtual prop crosses from a computing unit in a zone server to another computing unit by flying. Virtual energy of a unidirectional transfer event is deducted only in a cross-zone server process, thereby preventing the virtual event from being infinitely transmitted between zone servers.
(1) When unidirectional transmission is propagated in a zone server, consumption of event energy corresponding to a virtual event is related to a setting condition inside the zone server, and the setting condition includes a related condition affecting energy deduction. An example in which the related condition is implemented as an air condition is configured for description below.

When a virtual sub-map corresponding to a zone server is set to a vacuum state, if a unidirectional transfer event is transferred across computing units in the zone server, because different computing units in the same zone server are configured to manage different regions in the virtual sub-map corresponding to the zone server, transfer of a virtual event in different computing units is considered as transfer of the virtual event between different regions in the same virtual sub-map. In a vacuum environment, there is no resistance consumption, and energy in the zone server is conserved. Therefore, event energy corresponding to the virtual event is not reduced.

When the virtual sub-map corresponding to the zone server is set to a state in which there is air resistance, if a unidirectional transfer event is transferred in the zone server across computing units, the air resistance may cause energy consumption. When a condition of conservation of energy in the zone server is considered, event energy corresponding to a virtual event may be reduced, and the reduced energy may be dispersed in a sub-virtual world corresponding to the zone server in a form of thermal energy.

That is, when the unidirectional transfer event crosses different computing units in the same zone server, event energy of the unidirectional transfer event may be deducted or may remain unchanged according to the related condition affecting energy deduction.
(2) When a unidirectional transfer event crosses zone servers, event energy of the unidirectional transfer event may be deducted by using an additional setting condition. For example, when the unidirectional transfer event crosses from one zone server to another zone server, a preset quantity of energy value in the event energy is deducted, thereby effectively preventing a case in which a virtual event is infinitely transferred between zone servers.

Spread event: is one type of event in the embodiments and is an event including at least two propagation directions. The spread event has virtual energy and does not have virtual mass. The spread event may be transmitted from a local zone server to all zone servers logically connected to the local zone server, and virtual energy thereof attenuates with a propagation distance. Because, if the virtual energy is not attenuated, the spread event may be permanently transmitted in a virtual world of a game and does not disappear. When computing is performed on the same spread event transferred by different zone servers to the local zone server at the same time, corresponding virtual energy of the spread event in the local zone server may be accumulated. For example, the spread event may be an event that needs to be broadcast or notified, for example, a player obtains a reward, and a player obtains a match champion.

Computing unit: refers to a plurality of units obtained by division in a zone server, and one zone server includes at least two computing units. The computing unit is similar to a plurality of parallel computing cores inside a graphics processing unit (GPU). All events occurring in the same computing period by computing units in the same zone server are at the same time but at different locations. In a computing unit, it may be considered that all events within the same computing period occur at the same time and at the same location. According to this definition, because a distance is relatively close, a theory of relativity effect may be neglected, and a classical mechanics manner is returned to. That is, in the same zone server, all virtual elements and events may still directly run according to the same clock and computing period in the related technology.

Cloud technology: is a hosting technology that unifies a series of resources, such as hardware, software, and a network, in a wide region network or a local region network, to implement computing, storage, processing, and sharing of data.

A cloud technology is a general term of a network technology, an information technology, an integration technology, a management platform technology, and an application technology that are applied based on a cloud computing business model. The cloud technology may form a resource pool and be used as required, and is flexible and convenient. The cloud computing technology will become an important support. A background service of a technology network system requires a large amount of computing and storage resources, such as a video website, a picture website, and more portals. With rapid development and application of the Internet industry, each item may have its own identification mark in the future. The identification mark needs to be transmitted to a background system for logical processing. Data at different levels will be processed separately. All types of industry data need to be supported by a powerful system, which can only be implemented through cloud computing.

Cloud gaming: may also be referred to as gaming on demand, and is an online game technology based on a cloud computing technology. The cloud gaming technology enables a thin client with relatively limited graphics processing and data computing capabilities to run high-quality games. In a cloud gaming scenario, a game does not run on a game terminal of a player, but runs on a cloud server, and the cloud server renders a game scenario as a video/audio stream and transmits the video/audio stream to the game terminal of the player via a network. The game terminal of the player does not need to have a powerful graphics computing and data processing capability, and only needs to have a basic streaming media playback capability and a capability of obtaining an instruction inputted by the player and transmitting the instruction to the cloud server.

In this disclosure, a prompt interface or a pop-up window can be displayed, or voice prompt information can be outputted before collecting user-related data and when collecting user-related data. The prompt interface, the pop-up window, or the voice prompt information is configured for prompting the user that user-related data is currently being collected. In this way, in this disclosure, related operations of obtaining the user-related data only start to be executed after obtaining a confirmation operation of the user on the prompt interface or the pop-up window. Otherwise (that is, the confirmation operation of the user on the prompt interface or the pop-up window is not obtained), the related operations of obtaining the user-related data are ended, that is, the user-related data is not obtained. In other words, all user data collected by this disclosure is collected with the consent and authorization of the user, and the collection, use, and processing of user-related data need to comply with relevant laws, regulations, and standards of relevant regions.

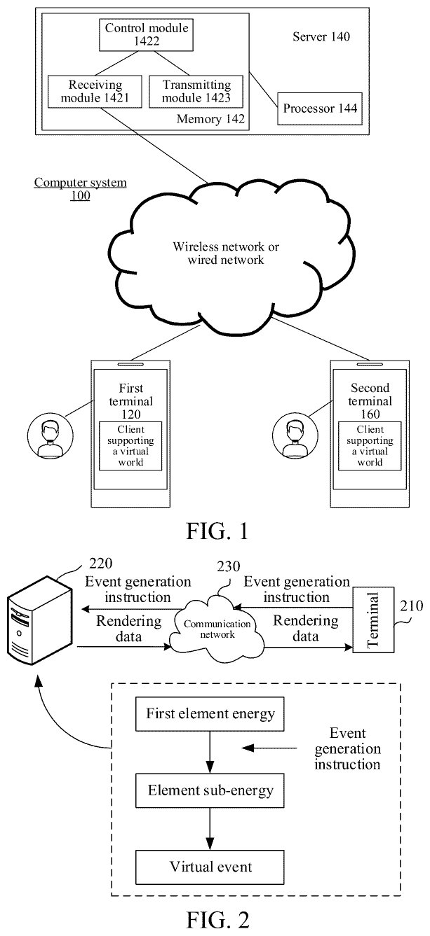

FIG. 1 is a structural block diagram of a computer system according to an embodiment of this disclosure, and the computer system may be referred to as a system architecture implementing a virtual world-based information transfer method. The computer system 100 includes: a first terminal 120, a server 140, and a second terminal 160.

The first terminal 120 is installed with and runs a client that provides support for the virtual world. For example, the client may be any one of a battle royale shooting game, a virtual reality (VR) client, an augmented reality (AR) program, a three-dimensional map program, a VR game, an AR game, a first-person shooting game (FPS), a third-person shooting game (TPS), a multiplayer online battle arena (MOBA) game, and a simulation game (SLG).

The first terminal 120 is a terminal used by a first user. The first user uses the first terminal 120 to control a first virtual object located in the virtual world. The control includes but is not limited to at least one of adjusting a body posture, crawling, walking, running, riding, jumping, driving, picking, shooting, attacking, throwing, constructing a virtual building, and crossing to a sub-virtual world corresponding to another server.

The first terminal 120 is connected to the server 140 by using a wireless network or a wired network.

The server 140 may be an independent physical server, or may be a server cluster including a plurality of physical servers or a distributed system, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server 140 includes at least one of one server, a plurality of servers, a cloud computing platform, or a virtualization center.

For example, the server 140 includes a processor 144 and a memory 142. The memory 142 further includes a receiving module 1421, a control module 1422, and a transmitting module 1423. The receiving module 1421 is configured to receive a request transmitted by a client, such as a first view request for viewing a device or a second view request for viewing a location. The control module 1422 is configured to control rendering of a virtual world picture. The transmitting module 1423 is configured to transmit a response to the client, for example, transmit a current device to the client, or transmit a current location to the client. The server 140 is configured to provide a backend service for clients of the first terminal 120 and the second terminal 160.

In some embodiments, the server 140 undertakes primary computing work, and the first terminal 120 and the second terminal 160 undertake secondary computing work. Alternatively, the server 140 undertakes secondary computing work, and the first terminal 120 and the second terminal 160 undertake primary computing work. Alternatively, coordinated computing is performed among the server 140, the first terminal 120, and the second terminal 160 by using a distributed computing architecture.

In this embodiment, the server 140 is also referred to as a zone server. A server for deploying a virtual world includes a plurality of servers 140 of the same model or different models. A complete virtual world consists of a plurality of sub-virtual worlds, one sub-virtual world is deployed on one server 140, and one server 140 may be connected to different terminals. For example, the server 140 is connected to the first terminal 120 and the second terminal 160. That is, the first user and the second user are located in the same zone server, and sub-virtual worlds corresponding to the server 140 are displayed on the clients of the first terminal 120 and the second terminal 160. In this embodiment, a plurality of servers for deploying a virtual world respectively correspond to different virtual time zones (clocks are unsynchronized), and a quantity of servers may continuously increase, and the virtual world may continuously expand. Therefore, in this embodiment, there is no complete world map for the virtual world, and there is a complete sub-world map for a sub-virtual world corresponding to each server 140.

A client supporting a virtual world is installed and run on the second terminal 160. The client may be any one of a battle royale shooting game, a virtual reality (VR) application, an augmented reality (AR) program, a three-dimensional map program, a virtual reality game, an augmented reality game, a first-person shooting game (FPS), a third-personal shooting game (TPS), a multiplayer online battle arena game (MOBA), or a simulation game (SLG).

The second terminal 160 is a terminal used by the second user. The second user uses the second terminal 160 to control a second virtual object located in the virtual world. The control includes but is not limited to: at least one of adjusting a body posture, crawling, walking, running, riding, jumping, driving, picking, shooting, attacking, throwing, constructing a virtual building, and crossing to a sub-virtual world corresponding to another server.

In some embodiments, a virtual object controlled by the first user through the first terminal 120 and a virtual object controlled by the second user through the second terminal 160 are located in different locations in the same virtual world. In an example, the first user and the second user are in the same battle in the same virtual world.

In some embodiments, the client installed in the first terminal 120 is same as the client installed in the second terminal 160, or the clients installed in the two terminals are clients of the same type on different control system platforms. Forms of the clients installed on the first terminal 120 and the second terminal 160 are not limited in the embodiments of this disclosure, including but not limited to an application (App), an applet, or the like installed on the first terminal 120 and the second terminal 160, and may alternatively be in the form of a web page. The first terminal 120 may generally refer to one of a plurality of terminals, and the second terminal 160 may generally refer to one of a plurality of terminals. This embodiment is described by merely taking the first terminal 120 and the second terminal 160 as an example. Device types of the first terminal 120 and the second terminal 160 are the same, and device models may be different. The device type includes: at least one of a smartphone, a tablet computer, a wearable device, a personal computer (PC), a portable laptop computer, and a desktop computer. The following embodiments are described by using an example in which a terminal includes a smartphone.

It is noted that that the quantity of the above terminals may be more or less. For example, there may be only one terminal (that is, a user battles against artificial intelligence (AI)), or there may be 8 terminals (1v1v1v1v1v1v1v1, 8 users battle to be eliminated cyclically, and finally a winner is determined) or more. A quantity of terminals and a device type are not limited in the embodiments of this disclosure.

In some embodiments, the server may be alternatively implemented as a node in a blockchain system.

In a related technology, in a network game under a background of a virtual world, deployment of the virtual world is usually controlled by a server, and the server coordinates, based on an instruction transmitted by a terminal corresponding to a player and in a manner of delivering a computing resource, a game behavior indicated by the instruction. However, computing resources corresponding to the server are limited. When the server receives instructions transmitted by a large quantity of terminals and delivers a large quantity of computing resources for the virtual world to run, a problem of computing crashing easily occurs. Consequently, computing power consumption of the virtual world cannot be well controlled. Not only use experience of participating in a game by a player is greatly reduced, but also a huge computing load is increased to the server, and computing efficiency is affected.

In the embodiments of this disclosure, a running method for a virtual world is described, and may be performed by a server, so that a process of deploying a virtual world is implemented by performing the method by using the server. In some aspects, as shown in FIG. 2, it is a schematic diagram of running a virtual world by using a server. A terminal 210 and a server 220 are included, and the terminal 210 communicates with the server 220 by using a communication network 230.

In some aspects, a game application program is installed in the terminal 210. After a player opens the game program, the terminal 210 can render and display, by using a terminal screen, a game picture transmitted by the server 220. The game picture includes various pictures such as a game entering picture, a game hall picture, and a virtual world picture.

In some embodiments, the virtual world picture is configured for presenting a virtual world corresponding to a game, the virtual world includes a plurality of virtual elements, and the virtual elements are elements forming the virtual world, such as a virtual road surface, a virtual building, a virtual monster, a non-player character (NPC), and virtual objects controlled by different players.

In some embodiments, the terminal 210 receives various game operations performed by the player in the game application program, and generates an event generation instruction when the game operation is implemented as an event generation operation on a first virtual element in the plurality of virtual elements in the virtual world. The event generation instruction is configured for consuming first element energy of the first virtual element and generating a virtual event. Therefore, the event generation operation is configured for representing an operation of consuming the first element energy to generate a virtual event. In some aspects, the event generation operation is implemented as controlling a main control virtual object (the first virtual element) to interact with an NPC, the main control virtual object is the targeted first virtual element, and an interaction process is implemented as a virtual event. That is, an interaction process and the like are implemented by consuming first element energy of the main control virtual object.

The terminal 210 transmits the generated event generation instruction to the server 220 by using the communication network 230. After receiving the event generation instruction, the server 220 consumes, based on the event generation instruction, element sub-energy that is in the first element energy and that is required for completing the virtual event. In addition, the server 220 generates the virtual event based on the element sub-energy consumed by the first virtual element.

In some embodiments, the server 220 transmits rendering data for changing the virtual world based on the virtual event to the terminal 210, so that the terminal 210 displays a result of changing the virtual world based on the virtual event on a screen based on the rendering data.

Element energy of a virtual element is consumed to generate a virtual event, conservation of energy in a virtual world is kept, thereby avoiding problems of complex processing of various events by only a server and a large quantity of processing times. By means of energy maintenance and conversion processes of the virtual world, game reality is improved, and a problem of data processing inefficiency is reduced, so that problems such as a value imbalance and contradictions between previous and following settings in a related game can be avoided to a large extent. Computing power consumption of the server is controlled when running a game, thereby improving stability of the game, and further facilitating improving human-computer interaction efficiency.

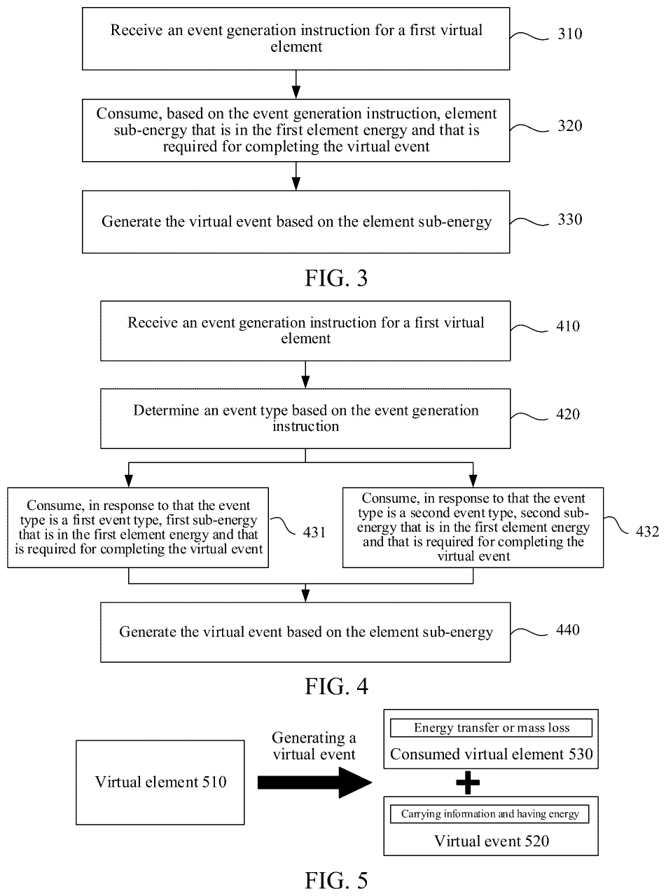

With reference to the foregoing noun introduction and application scenario, the running method for a virtual world provided in this disclosure is described. The method being performed by a computer device is used as an example. For example, a server performs the method. As shown in FIG. 3, the method includes the following operations 310 to 330.

Operation 310: Receive an event generation instruction for a first virtual element.

In some aspects, the virtual world controlled by the server for running includes a plurality of virtual elements. As elements constituting the entire virtual world, the virtual elements may be implemented as various physical elements such as a virtual ground, a virtual lake, a virtual sky, a virtual building, a virtual animal, a virtual plant, a virtual prop, and a virtual object in the virtual world. The first virtual element is an element forming the virtual world.

In some embodiments, the first virtual element is at least one virtual element in the plurality of virtual elements in the virtual world, and therefore, the first virtual element is also an element forming the virtual world.

In some aspects, the first virtual element is implemented as a main control virtual object controlled by a player. Alternatively, the first virtual element is implemented as a virtual treasure box placed on a virtual ground. Alternatively, the first virtual element is implemented as a virtual prop or the like that a player controls a main control virtual object to pick up.

The event generation instruction is configured for consuming first element energy of the first virtual element and generating a virtual event.

In some aspects, after receiving the event generation instruction, the server can determine, according to information carried in the event generation instruction, the first virtual element targeted by the event generation instruction.

For example, the plurality of virtual elements respectively has corresponding element identifiers, and the element identifiers are configured for uniquely referring to the virtual elements. The event generation instruction received by the server includes an element identifier corresponding to the first virtual element, so that the server determines, based on the element identifier, the first virtual element targeted by the event generation instruction.

The first element energy is energy corresponding to the first virtual element. In some aspects, the first virtual element is used as a physical form in the virtual world and has particular mass. The first element energy may also be considered as a manner of performing mass expression on the first virtual element.

In some embodiments, the plurality of virtual elements forming the virtual world respectively have corresponding element energy, and the element energy is configured for quantizing contributions of the virtual elements in the virtual world.

Element energy of different virtual elements may be the same or may be different. For example, element energy of a virtual element A is 50, and element energy of a virtual element B is also 50. Alternatively, the element energy of the virtual element A is 50, and the element energy of the virtual element B is 80.

Element energy of different types of virtual elements may be the same or may be different. For example, element energy of a virtual element A1 of type A is 50, element energy of a virtual element A2 of type A is also 50, and element energy of a virtual element B1 of type B is also 50. Alternatively, the element energy of the virtual element A1 of type A is 50, the element energy of the virtual element A2 of type A is also 50, and the element energy of the virtual element B1 of type B is 60. Alternatively, the element energy of the virtual element A1 of type A is 50, the element energy of the virtual element A2 of type A is 60, and the element energy of the virtual element B1 of type B is also 60. Alternatively, the element energy of the virtual element A1 of type A is 50, the element energy of the virtual element A2 of type A is 60, the element energy of the virtual element B1 of type B is 80, or the like.

In some embodiments, initial element energy of a virtual element is a value that is preset by a game developer in a game configuration process. Alternatively, the initial element energy of the virtual element is a value randomly allocated when a game starts, or the like.

In some aspects, as a game progresses, the initial element energy of the virtual element may change, and the change includes that the element energy increases, or the element energy decreases. The first element energy is configured for representing the element energy corresponding to the first virtual element. The first element energy may be implemented as initial element energy of the first virtual element, or may be implemented as element energy of the first virtual element after an energy change exists. This is not limited in this embodiment of this disclosure.

In some embodiments, the first virtual element is implemented as a physical element in the virtual world, and the first element energy of the first virtual element is implemented as element mass corresponding to the first virtual element.

In some embodiments, the event generation instruction is used as an instruction for consuming the first element energy and generating the virtual event, so that after determining the targeted first virtual element, the server performs a consumption process on the first element energy of the first virtual element, and generates the virtual event based on the effect.

The virtual event is an event unit running in the virtual world.

In some aspects, the virtual event is used as an event transmitted in the virtual world, and can represent various changes of the virtual world in a running process. For example, a virtual event 1 is implemented as interaction between a virtual object A1 and a virtual object A2 (for example, a conversation and hand clapping). Alternatively, a virtual event 2 is implemented as that the virtual object A1 kills a virtual monster B1 in the virtual world. Alternatively, a virtual event 3 is implemented as that the virtual object A1 runs in the virtual world, or the like.

The virtual object A1 may be considered as the first virtual element. The virtual event is event content expressed for the virtual object 1, and first element energy corresponding to the virtual object A1 needs to be consumed to implement the virtual event.

That is, the virtual event may be used as a medium for interaction between virtual elements, to avoid that a computing resource needs to be independently allocated by the server for interaction between the virtual elements for computing. Element energy of the virtual element is consumed to generate an event, thereby avoiding generation of the event without foundation. For example, the main control virtual object controlled by the player initiates a query on the NPC. A query process is considered as a virtual event corresponding to the main control virtual object. The query process consumes element energy of the main control virtual object to generate a query event.

The virtual element in the virtual world implements energy interaction through the virtual event.

In some aspects, when a virtual element needs to interact with another virtual element, an interaction process needs to be implemented in a manner of consuming element energy and generating a virtual event. That is, interaction between virtual elements needs to be implemented by using a virtual event, and the interaction process is implemented in a form of energy interaction, so that energy can be kept conserved in the virtual world.

Operation 320: Consume, based on the event generation instruction, element sub-energy that is in the first element energy and that is required for completing the virtual event.

In some aspects, the element sub-energy required for completing the virtual event is determined based on the first element energy corresponding to the first virtual element consumed by the event generation instruction.

The element sub-energy is sub-energy corresponding to the first element energy, and is configured for representing some energy corresponding to the first element energy. For example, the first element energy is implemented as A, and the element sub-energy is partial energy A1 in the first element energy A.

In some embodiments, the first element energy is implemented as energy composed of a plurality of pieces of sub-energy, and the element sub-energy is implemented as a particular quantity of sub-energy. For example, the first element energy is implemented as 100, and is implemented as energy consisting of 100 pieces of sub-energy. The element sub-energy is implemented as 67 pieces of sub-energy. Therefore, 67 is a first quantity, and the like.

In some embodiments, the server determines, based on the event generation instruction, a virtual event needing to be generated, to determine, based on the first virtual element targeted by the event generation instruction, sub-energy that needs to be obtained from the first element energy if the virtual event is completed as the element sub-energy.

In some embodiments, element sub-energy required to complete the virtual event is implemented as a value configured by a game developer.

For example, it is preset that a value of element sub-energy that needs to be consumed is 23 if a virtual event A is completed, and a value of element sub-energy that needs to be consumed is 48 if a virtual event B is completed. Alternatively, it is preset that a value of element sub-energy that needs to be consumed is 50 if a virtual event of type A is completed, or a value of element sub-energy that needs to be consumed is 30 if a virtual event of type B is completed.

In some embodiments, element sub-energy consumed for completing the virtual event is implemented as a value determined according to an object level of the main control virtual object.

The object level is a level of the main control virtual object controlled by the player in the virtual world. For example, the object level of the main control virtual object at the beginning of the game is level 1, and as the game progresses, the object level increases. For example, when the object level of the main control virtual object controlled by the player is implemented as level 3, the value of element sub-energy required to be consumed for completing the virtual event is 50. When the object level of the main control virtual object controlled by the player is implemented as level 5, the value of element sub-energy required to be consumed for completing the virtual event is 40 or the like.

In some embodiments, the element sub-energy required to complete the virtual event is implemented as a value determined according to running duration of the virtual world.

In some aspects, the running duration of the virtual world is running duration of the virtual world in a local game. For example, when a game starts, a value of element sub-energy that needs to be consumed for completing a virtual event is 10. After the game is played for a period of time, a value of element sub-energy that needs to be consumed for completing the virtual event is 20, and the like.

The foregoing is merely a schematic example. This is not limited in the embodiments of this disclosure.

Operation 330: Generate the virtual event based on the element sub-energy.

In some aspects, after the element sub-energy obtained from the first element energy is determined, the element sub-energy consumed by the first virtual element is used as energy for generating the virtual event.

In an embodiment, the virtual event is generated according to the element sub-energy consumed by the first virtual element.

For example, a value of consumed element sub-energy in the first element energy is 30, and the element sub-energy 30 is used as energy required for generating the virtual event.

In some embodiments, if the element sub-energy 30 is converted into event energy corresponding to the virtual event, a value of the event energy is 30, that is, the event energy corresponding to the virtual event may be equal to the element sub-energy.

In an embodiment, the event energy corresponding to the virtual event is determined.

For example, considering that when the element sub-energy is converted into the event energy corresponding to the virtual event, a part of energy may further need to be consumed to implement a conversion process, the event energy corresponding to the virtual event is determined.

In some embodiments, the event energy corresponding to the virtual event is implemented as a value configured by the game developer. Alternatively, the event energy corresponding to the virtual event is implemented as a value determined according to the object level of the main control virtual object. Alternatively, the event energy corresponding to the virtual event may be implemented as a value determined according to the running duration of the virtual world.

The event energy is less than the element sub-energy.

For example, the element sub-energy is energy for completing the virtual event, and the event energy is energy corresponding to the virtual event. Therefore, the event energy is less than the element sub-energy. For example, a value of the event energy corresponding to the virtual event is 30, and a value of the element sub-energy for completing the virtual event is 40.

In an embodiment, a difference between the element sub-energy and the event energy is used as event pushing energy to generate the virtual event.

The event pushing energy is configured for generating the virtual event.

For example, if the value of the element sub-energy for completing the virtual event is 40, the value of the event energy corresponding to the virtual event is 30, a value of the event pushing energy is 10, and a process of consuming the element energy corresponding to the first virtual element and generating the virtual event is implemented by using the event pushing energy.

The foregoing content describes a process of generating the virtual event based on the element sub-energy. The virtual event may be generated based on the element sub-energy. In this case, the element sub-energy is all converted into energy required by the virtual event, thereby fully converting the element sub-energy and avoiding a problem of energy waste. The event energy of the virtual event may also be determined, and further the event pushing energy of the difference between the element sub-energy and the event energy is used as the energy required for generating the virtual event, thereby enriching generation precisions of generating the virtual event, improving realness of the virtual event in a virtual scenario, and facilitating stable running of the virtual world.

The foregoing is merely a schematic example. This is not limited in the embodiments of this disclosure.

In conclusion, an event generation instruction for a first virtual element is received, and element sub-energy that is in first element energy and that is required for completing a virtual event is consumed based on the event generation instruction, to generate the virtual event based on the element sub-energy. By converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

In an embodiment, different energy consumption is performed on the first virtual element according to an event type of the generated virtual event. In some aspects, as shown in FIG. 4, the foregoing embodiment shown in FIG. 3 may further be implemented in the following operation 410 to operation 440, and operation 320 shown in FIG. 3 may further be implemented in the following operation 420 to operation 440.

Operation 410: Receive an event generation instruction for a first virtual element.

The event generation instruction is configured for consuming first element energy of the first virtual element and generating a virtual event. The first virtual element is an element forming the virtual world. The virtual event is an event unit running in the virtual world.

In an embodiment, the event generation instruction transmitted by a terminal is received.

The event generation instruction is an instruction generated by the terminal based on a received event generation operation.

In some aspects, the event generation instruction received by a server is an instruction generated and transmitted by the terminal, and the event generation operation received by the terminal is an operation performed on the first virtual element. That is, the event generation operation is configured for triggering the first virtual element.

For example, when a player controls, by operating the terminal, a main control virtual object to play a game in a virtual world, the player triggers any virtual element in the virtual world displayed by the terminal. If the trigger behavior instructs to interact with another virtual element in the virtual world, the virtual element is the first virtual element, the trigger behavior is an event generation operation, and an objective that the trigger behavior needs to achieve is a virtual event instructed to be generated by the event generation operation.

The foregoing content describes a process of generating the event generation instruction based on the event generation operation. The event generation operation is an operation received by the terminal for the first virtual element, and can adjust an energy state of the first virtual element, so as to interact with another virtual element in the virtual world. The terminal can generate the event generation instruction by using the event generation operation, so as to quantitatively generate the virtual event by using the event generation instruction, thereby more uniformly managing a running condition of the virtual world by using processes such as propagation and execution of the virtual event in the virtual world, and further improving running stability of the virtual world.

The virtual element in the virtual world implements energy interaction through the virtual event. Interaction between the first virtual element and another virtual element includes at least one of the following interaction forms.
(1) The first virtual element interacts with another specified virtual element.

In some aspects, if the trigger behavior performed by the player is implemented as the main control virtual object running in the virtual world, the first virtual element is the main control virtual object, and there is another specified virtual element implemented as a virtual ground. Alternatively, if the trigger behavior performed by the player is implemented as the main control virtual object having a dialog with an NPC, the first virtual element is the main control virtual object, and there is another specified virtual element implemented as the NPC.
(2) The first virtual element interacts with another unspecified virtual element

In some aspects, the trigger behavior performed by the player is implemented as publishing a virtual announcement on a square of the virtual world, the first virtual element is the main control virtual object, and there is another unspecified virtual element implemented as another virtual object viewing the virtual announcement. Alternatively, the trigger behavior performed by the player is implemented as spreading a virtual liquid medicine in the virtual world, the first virtual element is the main control virtual object, and another unspecified virtual element exists and is implemented as another virtual object healed by the virtual liquid medicine.

The foregoing is merely a schematic example. This is not limited in the embodiments of this disclosure.

Operation 420: Determine an event type based on the event generation instruction.

The event type is a type of the virtual event instructed to be generated by the event generation instruction.

In some aspects, if a process required for interaction between different virtual elements is referred to as a virtual event, there are a plurality of virtual events in the virtual world. Considering complexity of managing virtual events, virtual events of the same event type may be uniformly managed in advance.

In some aspects, the first virtual element is implemented as a main control virtual object, and interaction between the main control virtual object and another virtual object is considered as an event type (for example, event type 1). Interaction between the main control virtual object and different virtual monsters is considered as another event type (for example, event type 2). Interaction between the main control virtual object and a static virtual element is considered as another event type (for example, event type 3).

After the event generation instruction is received, the virtual event needing to be generated by the event generation instruction is determined, and the event type corresponding to the virtual event is determined.

In some aspects, the virtual event needing to be generated by the event generation instruction is implemented as interaction between the main control virtual object and a teammate virtual object (for example, clapping), and then it is determined that the event type corresponding to the virtual event is event type 1. Alternatively, the virtual event needing to be generated by the event generation instruction may be implemented as interaction between the main control virtual object and a virtual building (for example, attacking the virtual building), the event type corresponding to the virtual event is determined as event type 3.

Operation 431: Consume, in response to that the event type is a first event type, first sub-energy that is in the first element energy and that is required for completing the virtual event.

The first event type is configured for consuming the first sub-energy. The first sub-energy is element sub-energy consumed in the case of the first event type, the first sub-energy may also be referred to as first element sub-energy, and represents that the first sub-energy is element sub-energy having a first quantity.

In some aspects, managing a plurality of virtual events by using an event type includes managing an energy consumption situation corresponding to the event type.

In some embodiments, energy values respectively consumed by different event types are determined based on settings by the game developer. For example, event type 1 consumes 10 energy values; event type 2 consumes 14 energy values, and the like.

In some embodiments, when it is determined that the event type of the virtual event needing to be generated by the event generation instruction is the first event type, the first sub-energy is consumed based on the first event type. Therefore, when the first element energy corresponding to the first virtual element is consumed, the first sub-energy in the first element energy is deducted.

For example, the first event type is implemented as event type 1. When the first element energy corresponding to the first virtual element is consumed, a value of the first sub-energy in the first element energy is deducted by 10 energy values. That is, the 10 energy values are configured for representing the first sub-energy.

Operation 432: Consume, in response to that the event type is a second event type, second sub-energy that is in the first element energy and that is required for completing the virtual event.

The second event type is configured for consuming the second sub-energy. The second event type is different from the first event type. The second sub-energy is element sub-energy consumed in the second event type, and the second sub-energy may also be referred to as second element sub-energy, and represents that the second sub-energy is element sub-energy having a second quantity.

In some aspects, the second event type is implemented as event type 2. When the first element energy corresponding to the first virtual element is consumed, a value of the first sub-energy in the first element energy is deducted by 14 energy values. That is, the 14 energy values are configured for representing the second sub-energy.

In some embodiments, values of the first sub-energy and the second sub-energy may be the same. That is, energy values consumed by different event types may be the same. For example, event type 1 consumes 10 energy values; event type 2 also consumes 10 energy values, and the like. This is not limited in this embodiment of this disclosure.

In an embodiment, an energy requirement value required for completing the virtual event is determined based on the event generation instruction.

In some aspects, after the event generation instruction is received, the energy value required for completing the virtual event is determined as the energy requirement value. That is, the energy requirement value is configured for representing an energy value that needs to be consumed for completing the virtual event.

In some embodiments, the energy requirement value is implemented as event energy (or referred to as a value of event energy) corresponding to the virtual event. Alternatively, the energy requirement value is implemented as a sum of the event energy corresponding to the virtual event and the event pushing energy.

In an embodiment, in response to that the energy requirement value is not greater than the first element energy, the element sub-energy in the first element energy is consumed.

In some embodiments, when the energy requirement value required for completing the virtual event is not greater than the first element energy corresponding to the first virtual element, the element sub-energy in the first element energy is consumed. In this case, the energy value of the element sub-energy is the same as the energy requirement value.

In some aspects, when the energy requirement value is less than the first element energy, the element sub-energy in the first element energy is consumed.

As shown in FIG. 5, when a virtual event 520 is generated by consuming element energy of a virtual element 510, based on that an energy requirement value for completing the virtual event 520 is less than first element energy corresponding to the virtual element 510, element sub-energy having a magnitude equal to the energy requirement value is consumed, to generate the virtual event 520. The virtual event 520 carries information and energy. The information is event information and represents information expressed by the virtual event. The energy is event energy and represents energy determined based on the element sub-energy corresponding to the virtual element.

In addition, FIG. 5 further includes a consumed virtual element 530. The consumed virtual element 530 has energy transfer or a mass loss. The mass loss is because the virtual element 510 is presented in a physical form in the virtual world, and element energy of the virtual element may be regarded as a mass form.

For example, when the energy requirement value is equal to the first element energy, the element sub-energy in the first element energy is consumed, and the element sub-energy is equal to the first element energy.

In some embodiments, if the element sub-energy is equal to the first element energy, and the first element energy of the first virtual element is set to 0, the process of generating the virtual event cannot be continued, but the element energy may be increased by using another virtual event. Alternatively, if the element sub-energy is equal to the first element energy, because the first element energy is converted into element energy in the virtual world, the first virtual element disappears from the virtual world, but the element energy is reserved, and no energy disappears.

The foregoing content describes a process in which an event type is determined based on an event generation instruction, and different quantities of element sub-energy are consumed according to different event types. The virtual event instructed to be generated by the event generation instruction further correspondingly has an event type. Based on that the virtual event is an event unit running in the virtual world, different event types may also implement different tasks in the virtual world. The event type is used as a determining condition of a sub-energy consumption situation, helping to accurately determine a value of the element sub-energy, and improve diversity of virtual events and running flexibility of the virtual world while maintaining running stability of the virtual world, so that running of the virtual world is more realistic to a real world, and accuracy of determining the element sub-energy is improved.

In an embodiment, in response to that the energy requirement value is greater than the first element energy, consumption of the first element energy based on the event generation instruction is stopped.

In some aspects, when the energy requirement value required for completing the virtual event is greater than the first element energy corresponding to the first virtual element, the first element energy corresponding to the first virtual element cannot be enough for generating the virtual event. Therefore, the process of generating the virtual event cannot be implemented by consuming the first element energy. Therefore, the first element energy is no longer consumed.

In some embodiments, feedback information is transmitted to the terminal when the energy requirement value is greater than the first element energy, to instruct the terminal to replace the virtual event by using the feedback information. Alternatively, it is indicated, by using the feedback information, that the terminal cannot generate a virtual event.

The foregoing process describes content in which the energy requirement value is used as a defining condition for consuming the first element energy. Based on the event generation instruction, the energy requirement value required for completing the virtual event is determined, where only when the energy requirement value is not greater than the first element energy, the first element energy is available to be consumed, and then the element sub-energy required for completing the virtual event is determined from the first element energy, so as to generate the virtual event. If the energy requirement value is greater than the first element energy, the first element energy is less, and the virtual event cannot be generated in a manner of consuming the first element energy. Therefore, the process of consuming the first element energy based on the event generation instruction needs to be stopped. That is, whether the first element energy can be consumed to generate the virtual event is determined in a targeted manner according to a comparison result between the first element energy and the energy requirement value. A generation process of the virtual event is quantized by using the energy requirement value, to comply with running rules of the virtual world more meticulously.

Operation 440: Generate the virtual event based on the element sub-energy.

The first sub-energy and the second sub-energy are respectively energy consumption situations of the element sub-energy consumed in the first event type and the second event type.

For example, when the first element energy in the first virtual element is enough for consumption, and a consumed energy value is element sub-energy, a virtual event is generated based on the element sub-energy.

In an embodiment, the virtual event is implemented as at least two virtual sub-events.

In some aspects, the virtual event is an event A, and the virtual event includes a virtual sub-event A1 and a virtual sub-event A2.

In some embodiments, required energy respectively required for generating at least two virtual sub-events is determined, and the at least two required energy form element sub-energy.

For example, required energy required to complete the virtual sub-event A1 is 32, required energy required to complete the virtual sub-event A2 is 26, and element sub-energy corresponding to the virtual event A is 58.

In some embodiments, the element sub-energy is allocated based on the required energy, to obtain an allocation result.

For example, based on that the required energy required by the virtual sub-event A1 is 32, an energy value allocated to the virtual sub-event A1 is 32. Based on that the required energy required by the virtual sub-event A2 is 26, an energy value allocated to the virtual sub-event A2 is 26, and a result of the allocated energy value is referred to as an allocation result.

In some embodiments, at least two virtual sub-events are generated based on the allocation result.

In some aspects, based on the allocation result, a corresponding virtual sub-event is generated by using an energy value represented by the allocation result, that is, the virtual sub-event A1 is generated by using the energy value 32 allocated to complete the virtual sub-event A1; and the virtual sub-event A2 is generated by using the energy value 26 allocated to complete the virtual sub-event A2.

The foregoing content describes a process of generating a virtual sub-event when a virtual event is implemented as at least two virtual sub-events. Required energy required by the at least two virtual sub-events are respectively determined, to pertinently divide the element sub-energy based on the required energy, to obtain an allocation result representing a sub-energy value allocated to a virtual sub-event, so as to generate the at least two virtual sub-events according to the allocation result. At least two virtual sub-events may be generated simultaneously by using one event generation instruction, which improves event generation efficiency and helps improve accuracy of generation of the virtual sub-events by using an allocation result in a targeted manner, thereby improving stability of running the virtual world based on the virtual event.

In an embodiment, a server configured for deploying the virtual world includes a plurality of zone servers.

In some aspects, a device configured for deploying the virtual world is implemented as a server, for example, a physical server or a cloud server. The server correspondingly includes a plurality of zone servers. The zone server is a regional server. The plurality of zone servers are configured for jointly deploying the virtual world, and the plurality of zone servers are respectively configured for deploying virtual sub-worlds in the virtual world.

In this embodiment of this disclosure, there is relative independence between the plurality of zone servers. The relative independence corresponding to the zone server is reflected in a local inertial reference system followed by the zone server. Local inertial reference systems respectively followed by the plurality of zone servers may be different. That is, a global uniform clock does not need to be maintained, and only each independent zone server in the game needs to use the server as a local inertial reference system to maintain its own clock. For example, a zone server 1 maintains a clock 1 thereof. The clock 1 may be set to a 24-hour format. A zone server 2 maintains a clock 2 thereof, and the clock 2 is set to a 48-hour format. The clock 1 and the clock 2 are different clocks.

A plurality of zone servers are respectively configured for managing at least one virtual element. That is, each zone server can manage at least one virtual element in the virtual world.

There is no overlapping relationship between virtual elements respectively managed by the plurality of zone servers. For example, the server includes two zone servers. A zone server 1 is configured to manage a virtual element A and a virtual element B, and a zone server 2 is configured to manage a virtual element C and a virtual element D.

In an embodiment, in response to that the first virtual element targeted by the event generation instruction is managed by a first zone server in the plurality of zone servers, the virtual event is generated in the first zone server.

In some aspects, if the received event generation instruction is an instruction performed for the first virtual element, a zone server managing the first virtual element is determined in the plurality of zone servers as the first zone server, and in the first zone server, element sub-energy required for completing the virtual event in first element energy is consumed based on the event generation instruction, so as to generate the virtual event based on the element sub-energy. The virtual event is located in the first zone server.

The foregoing content describes a generation environment for generating a virtual event. If the first virtual element targeted by the event generation instruction is managed by the first zone server, the virtual event is generated in the first zone server. The first zone server not only can manage the first virtual element, but also can consume the first element energy of the first virtual element, so as to obtain the virtual event through conversion. The process of converting the virtual event is implemented in the zone server, which is beneficial to avoiding energy waste, can also maintain stability of event conversion, improve event conversion efficiency, and avoid a problem of inefficiency of executing an event generation process by another zone server.

In some embodiments, a server for deploying the virtual world includes a plurality of zone servers, and at least one of the plurality of zone servers includes a plurality of computing units.

The computing unit is configured to manage at least one virtual element in a zone server.

In some aspects, each zone server includes at least one computing unit, and a plurality of computing units are respectively configured to manage at least one virtual element in the zone server.

In some embodiments, in response to that the first virtual element targeted by the event generation instruction is managed by a first computing unit in the plurality of computing units, the virtual event is generated in the first computing unit.

In some embodiments, a server for deploying the virtual world includes a plurality of zone servers, and when each zone server includes a plurality of computing units, the computing unit is used as a generation location in a virtual event generation process. For example, when a zone server includes a plurality of computing units, the plurality of computing units present cellular division in a sub-virtual world corresponding to the zone server, and each obtained hexagon region is a computing unit. Except computing units at borders, each computing unit is connected to six surrounding computing units. Information is also transmitted and exchanged between the computing units by using a virtual event.

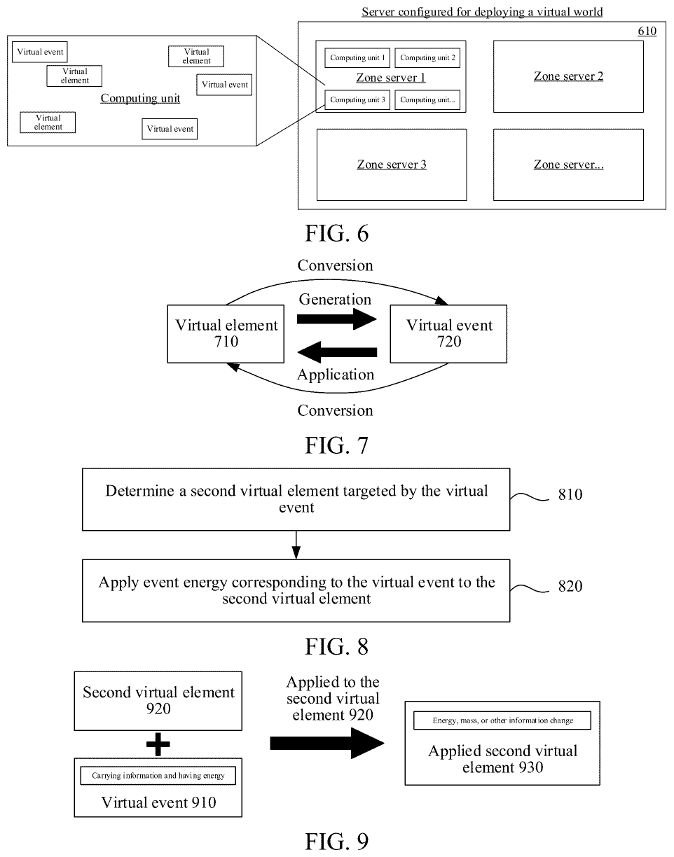

In some aspects, as shown in FIG. 6, it is a schematic framework diagram of a server configured for deploying a virtual world. A plurality of zone servers 610 are included, for example, a zone server 1, a zone server 2, and a zone server 3. Any zone server (such as the zone server 1) is used as an example and includes a plurality of computing units, for example, a computing unit 1, a computing unit 2, and a computing unit 3. Any computing unit (such as the computing unit 3) is used as an example, the computing unit is configured to manage a plurality of virtual elements in the virtual world, and after an event generation instruction for a virtual element is received, a virtual event is generated in the computing unit, so that both the virtual element and the virtual event exist in the computing unit.

In some embodiments, a server for deploying the virtual world includes a plurality of zone servers. When each zone server includes one computing unit, a zone server in which the computing unit is located is considered as the computing unit, and the computing unit (or referred to as a zone server) is used as a generation location in a virtual event generation process.

In some aspects, the first virtual element may be managed in a more detailed manner by using a computing unit in a zone server. If both the first virtual element and the second virtual element are virtual elements managed by the zone server 1, the first virtual element is a virtual element managed by the computing unit 1 in the zone server 1, and the second virtual element is a virtual element managed by the computing unit 2 in the zone server 1, so that the virtual elements are managed in a more detailed manner by using the computing unit under zone server management.

The foregoing content describes content of a virtual event generated by a first computing unit managing a first virtual element. If the first virtual element targeted by the event generation instruction is managed by the first computing unit, the virtual event is generated in the first computing unit, so that the first computing unit can consume the first element energy of the first virtual element, to obtain the virtual event through conversion. Management of the virtual element in the zone server is further refined by using the computing unit, so that conversion of the virtual event is more accurate, thereby avoiding energy waste and improving event conversion stability. A plurality of event conversion processes may also be performed in one zone server simultaneously through division of the computing unit, thereby improving event conversion efficiency.

The foregoing is merely a schematic example. This is not limited in the embodiments of this disclosure.

In an embodiment, the virtual element is represented by using an element vector. The element vector includes an element attribute component, an element zone server component, an element location component, and an element moment component.

The element attribute component is configured for representing an element attribute of the virtual element.

For example, the element attribute is implemented as an element type of a virtual element, for example, a virtual element a is a virtual element of type A. The element attribute is implemented as an element identifier of a virtual element, and is configured for uniquely identifying the virtual element, so as to be distinguished from another virtual element. Therefore, the element attribute component corresponding to the virtual element is configured for representing the virtual element is what virtual element.

In some embodiments, the element energy corresponding to the virtual element is stored in the element attribute component. When the virtual element consumes the element energy or adds the element energy, the element attribute component changes.

The element zone server component is configured for representing a zone server in which the virtual element is located.

In some aspects, based on different zone servers respectively having virtual elements correspondingly managed, when an element zone server component corresponding to a virtual element is determined, a zone server managing the virtual element is determined, so as to determine, based on the zone server, an element zone server component corresponding to the virtual element. For example, if a zone server managing the virtual element a is the zone server 1, an element zone server component corresponding to the virtual element a is determined based on the zone server 1. Therefore, the element zone server component corresponding to the virtual element is configured for representing that the virtual element is a virtual element located in which zone server in the plurality of zone servers.

The element location component is configured for representing location information of the virtual element in a zone server in which the virtual element is located.

In some aspects, based on that a server for deploying the virtual world includes a plurality of zone servers, different zone servers may be responsible for managing different regions (different sub-virtual worlds) of the virtual world, and a process of managing the virtual world by using the plurality of zone servers is implemented. Considering that different zone servers manage different sub-virtual worlds under the virtual world, after a zone server in which a virtual element is located is determined, a location status of the virtual element in a sub-virtual world managed by the zone server may further be determined, to determine an element location component corresponding to the virtual element.

For example, the zone server 1 is responsible for managing a sub-virtual world A in the virtual world, the virtual element a is an element managed by the zone server 1, and then the virtual element a is located in the sub-virtual world A in the virtual world, and a location status of the virtual element a in the sub-virtual world A is determined. For example, if location coordinates of the virtual element a in the sub-virtual world A are (1, 2), an element location component corresponding to the virtual element a is determined based on the location coordinates. Therefore, the element location component corresponding to the virtual element is configured for representing a spatial location in a zone server in which the virtual element is located.

In some embodiments, when at least one of the plurality of zone servers includes a plurality of computing units, the plurality of computing units are separately configured to manage at least one virtual element in a plurality of virtual elements managed in the zone server, and the virtual elements managed by the plurality of computing units do not overlap with each other. For example, the zone server 1 in the plurality of zone servers includes a plurality of computing units (a computing unit 1 and a computing unit 2). The zone server 1 manages the sub-virtual world A, and the computing unit 1 manages a region A1 under the sub-virtual world A. In this case, a plurality of virtual elements located in the region A1 are virtual elements managed by the computing unit 1. The computing unit 2 manages a region A2 under the sub-virtual world A, and a plurality of virtual elements located in the region A2 are virtual elements managed by the computing unit 2.

In some aspects, when a plurality of computing units are included in the zone server, and the element location component corresponding to the virtual element is determined, the computing unit managing the virtual element is determined, and further, the computing unit obtains, according to a location status (for example, location coordinates, relative location information of a region managed by the computing unit) of the virtual element in a region managed by the virtual element, the element location component corresponding to the virtual element.

The element moment component is configured for representing time information of the virtual element in a zone server in which the virtual element is located.

In some aspects, a server configured to deploy the virtual world includes a plurality of zone servers, and the plurality of zone servers respectively have corresponding clocks. Therefore, when the element moment component corresponding to the virtual element is determined, first, the zone server managing the virtual element needs to be determined, and then the element moment component is determined according to the clock corresponding to the zone server.

For example, a zone server managing the virtual element a is the zone server 1, and a clock followed by the zone server 1 is determined. For example, if the clock followed by the zone server 1 is a 24-hour format, the element moment component corresponding to the virtual element a in the zone server 1 is determined based on the clock. Therefore, the element moment component corresponding to the virtual element is configured for representing a moment situation when the virtual element is located in the current zone server.

In conclusion, an element vector corresponding to a virtual element includes the foregoing four element components, and therefore may be represented as [what, which, where, when]. What is configured for representing an element attribute component (what component for short below), and represents a virtual element is what virtual element. Which is configured for representing an element zone server component (which component for short below), and represents a zone server in which the virtual element is located (different zone servers have respective corresponding local inertial reference systems, and therefore may also be referred to as the virtual element is located in which local inertial reference system). Where is configured for representing an element location component (where component for short below), and represents a location status of a virtual element in a zone server (different zone servers have respective corresponding local inertial reference systems, and therefore, may also be referred to as the virtual element is located in which spatial location in the local inertial reference system). When is configured for representing an element moment component (when component for short below), and represents a moment situation of the virtual element in a zone server (based on different zone servers having respective corresponding local inertial reference systems, and therefore, may also be referred to as moment information of the virtual element in the local inertial reference system).

The foregoing content describes an element vector composition situation of a virtual element represented by using an element vector. By means of at least one type of information of the element attribute component, the element zone server component, the element location component, and the element moment component, existence of a virtual element relative to a zone server may be expressed from the perspective of at least one of the element attribute, the element zone server, the element location, and the element moment. This facilitates management of the virtual element by the zone server, and also facilitates understanding of the virtual element by another zone server, thereby enhancing a representation form of the virtual element relative to the zone server and expression of meaning information of the virtual element itself.

In an embodiment, the virtual event is represented by using an event vector. The event vector includes an event attribute component, an event zone server component, an event location component, and an event moment component.

The event attribute component is configured for representing an event attribute of a virtual event.

For example, the event attribute is implemented as an event type of a virtual event, for example, the virtual event a is a virtual event of type A. The event attribute is implemented as an event identifier of a virtual event, and is configured for uniquely identifying the virtual event, so as to be distinguished from another virtual event. Therefore, the event attribute component corresponding to the virtual event is configured for representing the virtual event is what virtual event.

In some embodiments, event energy corresponding to a virtual event is stored in an event attribute component. When the virtual event consumes the event energy or element energy is converted into the event energy, the event attribute component changes.

The event zone server component is configured for representing a zone server in which the virtual event is located.

In some aspects, the virtual event is obtained based on a virtual element. When the virtual event is generated, the virtual event is generated in a zone server corresponding to the virtual element. For example, the virtual element a targeted by the event generation instruction is located in the zone server 1. When element energy corresponding to the virtual element a is consumed to generate a virtual event, the virtual event is generated in the zone server 1. That is, when element energy of a virtual element under any zone server is consumed to generate a virtual event, the virtual event is generated under the zone server, that is, a virtual event is not generated across zone servers.

A zone server in which a virtual event is generated is used as an event zone server component corresponding to the virtual event, that is, a zone server in which a virtual element consumed to generate a virtual event is located is used as an event zone server component corresponding to the virtual event. Therefore, the event zone server component corresponding to the virtual event is configured for representing a zone server that generates the virtual event is what zone server.

The event location component is configured for representing location information of a virtual event in a zone server. Based on that a server for deploying the virtual world includes a plurality of zone servers, different zone servers may be responsible for managing different regions (different sub-virtual worlds) of the virtual world, and a process of managing the virtual world by using the plurality of zone servers is implemented.

In some embodiments, after the zone server in which the virtual event is generated is determined, the event location component corresponding to the virtual event is determined based on a location status of the virtual event in the zone server when the virtual event is generated.

In some aspects, element energy of the virtual element a in the zone server 1 is consumed to generate a virtual event, a process of generating the virtual event is implemented at a location A in a sub-virtual world managed by the zone server 1, and an event location component corresponding to the virtual event is determined based on the location A. For example, the location A is used as an event location component corresponding to the virtual event.

In some embodiments, a process of generating a virtual event based on consumption of element energy of a virtual element is usually fast, and an event location component corresponding to the virtual event is determined based on a location status of the consumed virtual element in a zone server.

In some aspects, the element energy of the virtual element a in the zone server 1 is consumed to generate a virtual event, the virtual element a is located at a location B in the sub-virtual world managed by the zone server 1, and an event location component corresponding to the virtual event is determined based on the location B. For example, the location B is used as an event location component corresponding to the virtual event.

In some embodiments, when at least one of the plurality of zone servers includes a plurality of computing units, when element energy of a virtual element in any computing unit is consumed to generate a virtual event, the virtual event is generated in the computing unit. That is, a virtual event is not generated across computing units.

In some embodiments, when the event location component corresponding to the virtual event is determined, a location status of the virtual event in a region managed by the computing unit is determined when the virtual event is generated, so as to obtain the event location component corresponding to the virtual event. Alternatively, a virtual element consumed to generate the virtual event is determined, and a computing unit managing the virtual element is determined, so that the computing unit obtains an event location component corresponding to the virtual event according to a location status of the virtual element in a region managed by the computing unit.

The event moment component is configured for representing time information of the virtual event in the zone server in which the virtual event is located.

In some aspects, a server configured to deploy the virtual world includes a plurality of zone servers, and the plurality of zone servers respectively have corresponding clocks. Therefore, when an event moment component corresponding to a virtual event is determined, a zone server in which the virtual event is generated first needs to be determined, and then the event moment component is determined according to a clock corresponding to the zone server.

For example, a zone server in which the virtual event a is generated is the zone server 1, and a clock followed by the zone server 1 is determined. For example, if the clock followed by the zone server 1 is a 24-hour format, the event moment component corresponding to the virtual event a in the zone server 1 is determined based on the clock. Therefore, the event moment component corresponding to the virtual event is configured for representing a moment situation when the virtual event is located in the current zone server.

In conclusion, an event vector corresponding to a virtual event includes the foregoing four event components, and therefore may be represented as [what, which, where, when]. What is configured for representing an event attribute component. Which is configured for representing an event zone server component. Where is configured for representing an event location component. When is configured for representing an event moment component.

The foregoing content describes an event vector composition situation of a virtual event represented by using an event vector. By using at least one type of information of the event attribute component, the event zone server component, the event location component, and the event moment component, existence of a virtual event relative to a zone server may be expressed from at least one of perspectives of the event attribute, the event zone server, the event location, and the event moment. This not only facilitates a process of generating and managing the virtual event by the zone server, but also facilitates a process of receiving and analyzing the virtual event by another zone server. A representation form of the virtual event relative to the zone server and expression of meaning information of the virtual event are enhanced, so that the virtual event is transferred between different zone servers, thereby enhancing overall running stability of the virtual world.

In some embodiments, a representation form of an event vector corresponding to a virtual event is the same as a representation form of an element vector of a virtual element. Because the event vector corresponding to the virtual event is the same as the element vector of the virtual element in a mathematical representation form, the virtual element and the virtual event may be mutually converted and interact with each other, so as to participate in a running and operation process of the virtual world more flexibly.

In some aspects, as shown in FIG. 7, FIG. 7 is a schematic diagram of a conversion relationship between a virtual element and a virtual event.

A process of converting a virtual element 710 into a virtual event 720 may be implemented by consuming element energy of the virtual element 710. The conversion process is implemented as generating the virtual event 720 based on the virtual element 710. After the virtual event 720 is generated, the virtual event has some or all of the element energy corresponding to the virtual element 710, and energy of the virtual event 720 may be referred to as event energy.

In addition, a process of converting the virtual event 720 into the virtual element 710 may be implemented by consuming event energy of the virtual event 720. The conversion process is implemented as applying the virtual event 720 to the virtual element 710.

The conversion process shown in FIG. 7 is merely a general description of conversion between a virtual element and a virtual event, and a virtual element is merely a general description of a plurality of virtual elements. A virtual element consumed for generating a virtual event and a virtual element acted on by a virtual event may be implemented as the same virtual element, or may be implemented as different virtual elements. This is not limited in this embodiment of this disclosure.

In conclusion, by converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

In this embodiment of this disclosure, different content of energy consumption performed on the first virtual element according to the event type of the generated virtual event is described. An event type of a virtual event that needs to be generated is determined according to an event generation instruction for the first virtual element, and first sub-energy corresponding to first element energy is consumed when the event type is implemented as the first event type configured for consuming the first sub-energy, to generate the virtual event based on the first sub-energy. Division of event types can make an energy consumption and conversion process more real. Because different event types can consume different sub-energy of the first element energy, the realness and interest of the game are improved when conservation of energy is ensured.

In an embodiment, after the virtual event is generated, the virtual event is applied to the second virtual element in the virtual world. In some aspects, as shown in FIG. 8, after the embodiment shown in FIG. 3, the following operation 810 and operation 820 are further included.

Operation 810: Determine a second virtual element targeted by the virtual event.

In some aspects, when the virtual event is generated, the virtual event carries event information. The event information includes the second virtual element targeted by the virtual event. The second virtual element is configured for representing a virtual element receiving the virtual event, and may also be referred to as a virtual element to which the virtual event is applied.

In some embodiments, the second virtual element is implemented as a virtual element other than the first virtual element. That is, the first virtual element generating the virtual event and the second virtual element receiving the virtual event are different virtual elements.

In some aspects, the virtual event generated by the first virtual element is implemented as follows: The main control virtual object queries an NPC in the virtual world for a question about monster A, and then the query event is used as a virtual event, which carries event information such as an object targeted by the virtual event and the question queried by the virtual event. The object targeted by the virtual event is the NPC, that is, the second virtual element. The question queried by the virtual event is the question about monster A.

In some embodiments, the second virtual element is implemented as the first virtual element. That is, the first virtual element generating the virtual event and the second virtual element on which the virtual event acts are the same virtual element.

In some aspects, the virtual event generated by the first virtual element is implemented as follows: If the main control virtual object taps the head thereof, the tap event is used as a virtual event, and carries event information such as an object targeted by the virtual event and a location tapped by the virtual event. The object targeted by the virtual event is the main control virtual object, that is, the second virtual element, and the first virtual element generating the virtual event. The location tapped by the virtual event is the head of the main control virtual object.

The foregoing is merely a schematic example. This is not limited in the embodiments of this disclosure.

Operation 820: Apply event energy corresponding to the virtual event to the second virtual element.

The event energy is energy obtained based on conversion of the element sub-energy.

In some embodiments, when all the element sub-energy is configured for generating a virtual event, the energy value of the event energy is implemented as an energy value of the element sub-energy.

In some embodiments, when the element sub-energy is partially configured for facilitating generation of a virtual event (event pushing energy), and partially configured for generating a virtual event, the energy value of the event energy is implemented as an energy value other than the event pushing energy in the element sub-energy.

In some aspects, after the second virtual element targeted by the virtual event is determined, event energy corresponding to the virtual event is applied to the second virtual element, to complete a process of conversion from the virtual event to the virtual element.

In some embodiments, the virtual event acts on a plurality of virtual elements, that is, the second virtual element is implemented as a plurality of virtual elements.

In some aspects, when the event energy corresponding to the virtual event is applied to the second virtual element, event sub-energy respectively allocated to each second virtual element is determined from the event information carried in the virtual event, and corresponding event sub-energy is applied to the corresponding second virtual element according to the result.

For example, the second virtual element indicated by the virtual event includes a virtual element 1 and a virtual element 2. It is determined, in the event information carried in the virtual event, that event sub-energy allocated to the virtual element 1 is 3, and it is determined, in the event information carried in the virtual event, that event sub-energy allocated to the virtual element 2 is 5. Therefore, the event energy is applied to the virtual element 1 and the virtual element 2 based on the allocation result, thereby implementing a process of application to the second virtual element.

In an embodiment, in response to that the event energy corresponding to the virtual event reaches a preset trigger threshold for triggering the second virtual element, the event energy is applied to the second virtual element.

For example, the preset trigger threshold is implemented as a preset trigger threshold, and is a threshold condition for triggering the second virtual element to receive event energy.

For example, the event energy corresponding to the virtual event is 50. If the preset trigger threshold of the second virtual element is 30, the event energy corresponding to the virtual event reaches the preset trigger threshold for triggering the second virtual element, and the event energy can be applied to the second virtual element.

In some embodiments, in response to that the event energy corresponding to the virtual event does not reach the preset trigger threshold for triggering the second virtual element, the event energy cannot be applied to the second virtual element.

For example, the event energy corresponding to the virtual event is 30. If the preset trigger threshold of the second virtual element is 50, the event energy corresponding to the virtual event does not reach the preset trigger threshold for triggering the second virtual element, and the event energy cannot be applied to the second virtual element.

In some embodiments, the preset trigger threshold is determined by the virtual element.

For example, element types of different virtual elements are determined to have different preset trigger thresholds.

In some embodiments, the preset trigger threshold is determined by both the virtual element and the event type of the virtual event.

For example, the preset trigger threshold of the virtual element A when the virtual element A generates the virtual event B is a preset trigger threshold 1; and the preset trigger threshold of the virtual element A when the virtual element A generates the virtual event C is a preset trigger threshold 2.

Setting the preset trigger threshold can effectively avoid a problem that a virtual element is more randomly affected by a virtual event, thereby effectively avoiding disordered running of the virtual world, and improving realness of the virtual world to some extent.

In some embodiments, when the event energy cannot be applied to the second virtual element, the event energy is converted into virtual thermal energy for scattering in virtual air of the virtual world. Alternatively, when the event energy cannot be applied to the second virtual element, the event energy is applied to the first virtual element, so as to return element energy consumed from the first virtual element back to the first virtual element.

The foregoing content describes a process in which the event energy can be applied to the second virtual element only when the event energy reaches the preset trigger threshold. The preset trigger threshold is used as a condition by the second virtual element to determine and limit whether a virtual event can be applied to the second virtual element. When the event energy of the virtual event is less than the preset trigger threshold, the second virtual element rejects to apply the virtual event to the second virtual element. When the event energy of the virtual event reaches the preset trigger threshold, the second virtual element allows to apply the virtual event to the second virtual element, thereby avoiding a problem that any virtual event can trigger the second virtual element, and maintaining stability of the second virtual element in the virtual world. Only when the second virtual element reaches the preset trigger threshold, the second virtual element can change based on the virtual event. The running flexibility of the virtual world is enriched, and the running stability of the virtual world is ensured at the same time.

In an embodiment, the second virtual element corresponds to second element energy.

The second element energy is element energy of the second virtual element before the second virtual element is acted on by a virtual event.

In some aspects, the second element energy is implemented as initial element energy corresponding to the second virtual element. Alternatively, the second element energy is implemented as element energy of the second virtual element obtained after the second virtual element is acted on by at least one other virtual event. For example, the initial element energy of the second virtual element is a, and after the second virtual element is acted on by a virtual event 1, the second element energy of the second virtual element is caused to change to a+b. The virtual event generated based on the first virtual element is a virtual event 2, and the virtual event 2 is not applied to the second virtual element.

In an embodiment, the event energy corresponding to the virtual event is converted into element energy of the second virtual element, to obtain the second virtual element having third element energy.

The third element energy is a sum of the event energy and the second element energy.

In some aspects, the second element energy is a, the event energy corresponding to the virtual event is c, after the event energy corresponding to the virtual event is applied to the second virtual element, the element energy corresponding to the second virtual element is changed to the third element energy, and an energy value is implemented as a+c.

As shown in FIG. 9, after a virtual event 910 is generated, the virtual event 910 carries information (event information) and has energy (event energy), and the virtual event 910 is applied to a second virtual element 920, that is, event energy corresponding to the virtual event 910 is applied to the second virtual element 920, to obtain a second virtual element 930 after application, energy (element energy), mass (the mass is because the virtual element is presented in a physical form in the virtual world, and the element energy of the virtual element may be considered as a mass form), or other information (for example, a location) in the second virtual element 930 after application changes.

In an embodiment, first event sub-energy consumed in a process in which the virtual event reaches the second virtual element is determined, the first event sub-energy being less than the event energy; and a difference between the event energy and the first event sub-energy is determined, to obtain second event sub-energy; and the second event sub-energy is converted into element energy of the second virtual element, to obtain the second virtual element having fourth element energy.

The fourth element energy is a sum of the second event sub-energy and the second element energy.

For example, when event energy corresponding to a virtual event is applied to the second virtual element, energy needs to be consumed. First, it is determined that an energy group consumed when the virtual event is applied to the second virtual element is used as first event sub-energy, and further, it is determined, according to a difference between the event energy and the first event sub-energy, that energy formally acting on the second virtual element is second event sub-energy. Therefore, when the virtual event is applied to the second event sub-energy, the second event sub-energy is applied to the second virtual element, to obtain a second virtual element having the fourth element energy that is the sum of the second event sub-energy and the second element energy.

The foregoing is merely a schematic example. This is not limited in the embodiments of this disclosure.

The foregoing content describes a process in which the second virtual element having the second element energy adjusts the element energy thereof based on the event energy. After receiving the virtual event, the second virtual element can convert event energy corresponding to the virtual event into element energy of the second virtual element, so as to obtain the second virtual element having the third element energy, thereby implementing complete conversion of the element energy and avoiding a waste of the element energy. Alternatively, the first event sub-energy consumed in the process in which the virtual event reaches the second virtual element may be determined, so as to convert the second event sub-energy, which is the difference between the event energy and the first event sub-energy, into the element energy of the second virtual element, and obtain the second virtual element having the fourth element energy. The process fully considers the energy consumption problem that may exist in the conversion process, so that the second virtual element having the fourth element energy better conforms to energy conversion and energy consumption situations of the real world, thereby improving the running realness of the virtual world.

In an embodiment, the server configured to deploy the virtual world includes a plurality of zone servers, the element vector includes an element location component and an element moment component, and the event vector includes an event location component and an event moment component.

The plurality of zone servers are respectively configured for managing at least one virtual element.

In an embodiment, in response to that both the first virtual element and the second virtual element are managed by the first zone server, an event location component and an event moment component corresponding to the virtual event are determined, and an element location component and an element moment component corresponding to the second virtual element are determined.

The virtual element is represented by using an element vector. The element vector includes an element attribute component, an element zone server component, an element location component, and an element moment component. The virtual event is represented by using an event vector. The event vector includes an event attribute component, an event zone server component, an event location component, and an event moment component.

In some aspects, the first virtual element generating the virtual event and the second virtual element on which the virtual event acts are located in one zone server. Using an example in which the zone server is the first zone server, an event location component and an event moment component corresponding to the virtual event are determined, and an element location component and an element moment component corresponding to the second virtual element are determined.

The event location component corresponding to the virtual event is implemented as location coordinates corresponding to the virtual event when the virtual event is generated. Alternatively, the event location component corresponding to the virtual event is implemented as location coordinates or the like of the first virtual element generating the virtual event in the sub-virtual world corresponding to the first zone server. The event moment component corresponding to the virtual event is implemented as a moment corresponding to the first zone server when the virtual event is generated.

The element location component corresponding to the second virtual element is implemented as location coordinates and the like of the second virtual element in the sub-virtual world corresponding to the first zone server when the virtual event is applied to the second virtual element. The element moment component corresponding to the virtual element is implemented as a moment corresponding to the first zone server when the virtual event is applied to the second virtual element, and the like.

In an embodiment, in response to that the event location component is the same as the element location component, and the event moment component is the same as the element moment component, the event energy corresponding to the virtual event is applied to the second virtual element.

In some aspects, when it is determined that both an event location component and an event moment component corresponding to the virtual event can be the same as an element location component and an element moment component corresponding to the virtual element, the event energy corresponding to the virtual event may be applied to the second virtual element.

The foregoing content describes a process of comparing an element location component with an event location component, and comparing an element moment component with an event moment component, to determine whether to apply the event energy to the second virtual element. Considering that the element location component represents location information of the virtual element in a zone server, and the event location component represents location information of the virtual event in the zone server, whether the virtual element and the virtual event are located at the same location may be determined by comparing the element location component with the event location component. In addition, considering that the element moment component represents time information of the virtual element in a zone server in which the virtual element is located, and the event moment component represents time information of the virtual event in the zone server in which the virtual element is located, whether the virtual element and the virtual event are located at the same moment may be determined by comparing the element moment component and the event moment component, so that the same moment and the same location are used as an energy application condition, and the event energy can be applied to the second virtual element only when the two are the same, which is beneficial to improving resource utilization efficiency, and improving accuracy and application quality of energy application.

In an embodiment, an element attribute component of the second virtual element is adjusted by using the event energy corresponding to the virtual event.

In some aspects, in most cases, when a virtual event is applied to the second virtual element, what component of the second virtual element is changed. For example, this causes an increase or decrease in the element energy (element mass) of the second virtual element.

In some aspects, when the second virtual element is implemented as a virtual element such as text or a display screen, the effect of the virtual event may further change information recorded on the second virtual element, and the information is also a part of what component of the second virtual element.

In some aspects, after the virtual event is applied to the second virtual element, event energy of the virtual event does not vanish without foundation, but becomes a part of the element energy of the second virtual element, or is spread to a zone server, and conservation of mass energy is still maintained.

In some aspects, a zone server, a computing unit in the zone server, and a virtual element may select to ignore a virtual event with excessively low event energy. In this way, a function of the virtual event is ineffective, and only event energy is left to be spread to the zone server.

In an embodiment, an element location component of the second virtual element is adjusted by using the event energy corresponding to the virtual event.

In some examples, the event energy corresponding to the virtual event further changes location coordinates of the second virtual element in the virtual world, thereby implementing a process of adjusting the element location component of the second virtual element, and causing forcible displacement of the second virtual element.

For example, the virtual event is implemented as attacking a virtual monster, the second virtual element targeted by the virtual event is the virtual monster, and the attack operation may cause forcible displacement on the virtual monster, to implement a process of adjusting the element location component of the second virtual element by using event energy.

The foregoing content describes a process in which the event energy is applied to the second virtual element by adjusting the element component corresponding to the second virtual element by using the event energy. By adjusting at least one of the element attribute component and the element location component by using the event energy, the element energy of the second virtual element can be changed, to successfully apply the event energy to the second virtual element. An implementation of applying the event energy to the second virtual element is described, and a process of changing the second virtual element by using the virtual event is enriched.

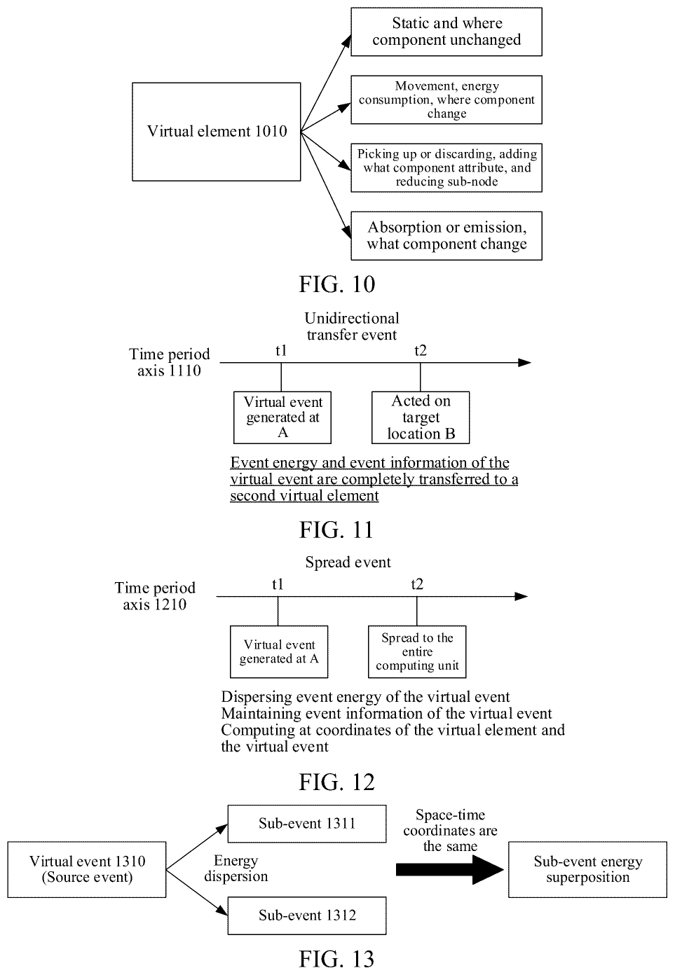

In some embodiments, as shown in FIG. 10, an element vector corresponding to a virtual element is described. Using any virtual element 1010 in a plurality of virtual elements as an example, all virtual elements in a game world are changing. Similar to how all objects are in perpetual motion within the four-dimensional space-time of relativity, even if an object's spatial coordinates remain fixed in a reference system, its temporal coordinates continuously evolve in the space-time diagram. For example, the main control virtual object controlled by the player needs to constantly absorb the element energy to supplement the element energy, so that the main control virtual object consumes the element energy to move to the static NPC, and in this period, the main control virtual object may pick up or discard an article to facilitate a game action.

In some embodiments, when the virtual element stays still in the zone server or is not affected by another virtual event, when component in the element vector pushes along with a clock of the zone server, and the other components remain unchanged. In actual engineering practice, when component of the element may not be stored in the element object, and when the element participates in an operation, the clock of the zone server is directly used.

In some embodiments, similar to the Pauli exclusion principle in physics, there cannot be the same where component and the same when component at the same time between each two virtual elements in a zone server (or a computing unit), that is, one point in the space-time coordinates (the time coordinates and the space coordinates) can only accommodate one virtual element at most. That is, two different virtual elements cannot be located at the same location at the same moment corresponding to one zone server.

In some embodiments, the virtual element moves in the zone server, that is, where component changes, and this process needs to consume element energy, that is, an energy attribute in where component is reduced. For example, when the main control virtual object controlled by the player runs, element energy on the main control virtual object decreases, and the main control virtual object cannot move when the element energy is insufficient.

In some aspects, what component includes various element information corresponding to the virtual element, the element information is represented in a form of a tree structure, the tree structure includes a plurality of sub-nodes, and different sub-nodes separately store some information in the element information. Element information of different virtual elements is different, and therefore tree structures respectively corresponding to the different virtual elements are different. For example, there are differences between a quantity of sub-nodes forming the tree structure and some stored information. When a virtual element is picked up or discarded, what component corresponding to the virtual element changes, and a sub-node is added or subtracted from what component (the element attribute still exists, but changes). When a virtual element is absorbed or emitted, what component corresponding to the virtual element changes (the element attribute does not exist any longer).

In some embodiments, using an example in which the main control virtual object moves in the virtual world, element energy consumed during the movement (element energy corresponding to the main control virtual object) does not disappear without foundation. Similar to thermal energy, the element energy is spread to a computing unit corresponding to a region in which the main control virtual object is located (or a zone server corresponding to the sub-virtual world in which the main control virtual object is located). In some aspects, some virtual elements in the computing unit or the zone server may further obtain scattered element energy. For example, virtual objects controlled by different players may automatically absorb element energy spread in the zone server to increase their own element energy (energy value). Such an energy mechanism can effectively prevent the extra computing load on the virtual world's operation caused by player behaviors such as script-based idling.

In some embodiments, if a virtual element wants to increase its element energy (for example, element mass), this may be implemented by picking up or absorbing energy of another element in a zone server. Similar to digesting and absorbing and wearing, an original attribute of a virtual element remains unchanged after being picked up, and may become an independent virtual element again after being discarded. Only after the element is absorbed, the element completely becomes a part of the absorber, and attributes of all elements do not exist any longer, and cannot be restored to independent virtual elements.

In some embodiments, the virtual element is limited to move in a zone server and cannot cross different zone servers. If crossing zone servers is required, this may be implemented by using a method of converting a virtual element into a virtual event.

The foregoing is merely a schematic example. This is not limited in the embodiments of this disclosure.

In conclusion, by converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

In this embodiment of this disclosure, the content that a virtual event generated by using a first virtual element is applied to a second virtual element is described. When the virtual event is implemented as a unidirectional transfer event, the second virtual element targeted by the generated virtual event is determined, so that when the virtual event is applied to the second virtual element, the event energy of the virtual event is applied to the second virtual element, so as to change the second element energy before the second virtual element is acted on by the virtual event, to obtain the second virtual element having the third element energy, thereby implementing a process in which the first virtual element and the second virtual element interact with each other by using the virtual event. By using the virtual event as a medium, it is avoided that the virtual event is generated in the virtual world without foundation, which is beneficial to maintaining conservation of energy in the virtual world.

In an embodiment, the generated virtual event is implemented in two forms: a unidirectional transfer event and a spread event. The unidirectional transfer event is an event in which a fixed propagation direction is set, and has an explicitly targeted second virtual element. The spread event is an event including at least two propagation directions, and a virtual element on which action is performed has some randomness.

In some embodiments, when the virtual event is a unidirectional transfer event, an action process is implemented based on a second virtual element indicated by the unidirectional transfer event.

As shown in FIG. 11, a time period axis 1110 is a time meter scale of a clock corresponding to a zone server where a first virtual element and a second virtual element are located, and includes a moment t1 and a moment t2. A virtual event is generated at A at the moment t1 (that is, a location A of a sub-virtual world managed by a zone server), and the virtual event is applied to B at the moment t2 (that is, a location B of the sub-virtual world managed by the zone server), where B is a location of the second virtual element in the sub-virtual world. In a transfer process of the unidirectional transfer event shown in FIG. 11, event energy and event information of the virtual event are completely transferred to the second virtual element.

In some embodiments, at the level of the computing unit, a function of a virtual event on a virtual element therein is directly completed in one computing period. Because a relativistic effect is ignored in the computing unit, it is considered that information is propagated at an infinite speed.

In some embodiments, a unidirectional transfer event directly acts on a virtual event or a virtual element at a designated location in a next computing period, that is, an action may be generated only when where component and when component are simultaneously equal in the same computing unit.

In some embodiments, when the virtual event is a spread event, a process of searching for the virtual element acted on by the virtual event is implemented based on the spread event.

As shown in FIG. 12, a time period axis 1210 is a time meter scale of a clock corresponding to a zone server where a first virtual element and a second virtual element are located, and includes a moment t1 and a moment t2. A virtual event is generated at A at the moment t1 (that is, a location A of a sub-virtual world managed by a zone server), and the virtual event is spread to the entire computing unit (or the zone server, where the computing unit is used as an example herein) at the moment t2. In a transfer process of the spread event shown in FIG. 12, event energy of the virtual event is dispersed (for example, dispersed to locations of a computing unit), event information of the virtual event is maintained, and there is a process of performing computing on coordinates of the virtual element and the virtual event, that is, a computing process in which there is an element location component corresponding to the virtual element and an event location component corresponding to the virtual event.

In an embodiment, when the virtual event is implemented as a spread event, if a zone server completes a process of applying the virtual event to the virtual element, the virtual event is traversed at each location in a sub-virtual world corresponding to the zone server, so as to apply the virtual event to the virtual element indicated by the virtual event. If the computing unit completes a process of applying the virtual event to the virtual element, the virtual event is traversed at each location in the region corresponding to the computing unit, so as to apply the virtual event to the virtual element indicated by the virtual event.

In some embodiments, the event energy corresponding to the virtual event is broadcast, to obtain a plurality of pieces of event sub-energy, and the plurality of pieces of event sub-energy correspond to different location components.

In some aspects, different event sub-energy is respectively marked with vectors related to the virtual event, and includes an attribute component indicating an energy value corresponding to the event sub-energy, a zone server component indicating a zone server in which the virtual event is located, a location component indicating location information of the event sub-energy in the zone server, and a moment component indicating moment information of the event sub-energy in the zone server.

In some embodiments, in response to that a third virtual element exists at a location indicated by a location component of third event sub-energy, the third event sub-energy is applied to the third virtual element.

The third event sub-energy is event sub-energy in the plurality of pieces of event sub-energy.

In some aspects, the third event sub-energy is any one of the plurality of pieces of event sub-energy. If it is determined, according to the location component corresponding to the third event sub-energy, that the virtual element exists at the indicated location, the virtual element is used as the third virtual element, and the third virtual element is a virtual element configured for being acted on by the third event sub-energy.

The third event sub-energy is applied to the third virtual element based on the location component. For example, the energy value is applied to the third virtual element based on an energy value that corresponds to the third event sub-energy and that is indicated by the attribute component in the third event sub-energy, to implement an action process.

In some embodiments, when at least one piece of event sub-energy exists in the plurality of pieces of event sub-energy, the third virtual element is determined based on the corresponding location component, and the at least one pieces of event sub-energy is respectively used as the foregoing third event sub-energy, to implement a process of applying the spread event to the virtual element.

In some embodiments, a spread event generated in the computing unit is directly spread to the entire computing unit in a generated next computing period, which causes event energy of a virtual event to be evenly distributed to the computing unit. An operation is performed only when there is a virtual element or space-time coordinates of a virtual event, and in most cases, event sub-energy of a spread event becomes weak and is ignored. Consequently, information cannot be transferred or an impact can be caused to the virtual element.

In some embodiments, when the event energy corresponding to the virtual event is applied to the second virtual element, the second virtual element may reject the action process.

In some aspects, if the virtual event is directly applied to the second virtual element in the computing unit, the second virtual element may correspondingly change. For example, the main control virtual object states a fact to the NPC, and then the NPC may obtain information that is not known before, and knowledge of the information is abundant, so that what component of the second virtual element changes. In addition, the NPC may also reject to accept the stated fact.

The foregoing content describes a process of applying event sub-energy to a virtual element by broadcasting event energy. When the virtual event is implemented as a spread event, event energy corresponding to the virtual event may be broadcast to obtain a plurality of pieces of event sub-energy corresponding to different location components, so that when the third virtual element exists at a location indicated by a location component of the third event sub-energy, the third event sub-energy may be applied to the third virtual element, thereby influencing a virtual element in the virtual world by means of a virtual event in a spread form. A degree of orientation of the spread event is relatively low, facilitating wider influencing of the virtual world, facilitating propagation of the event energy when the virtual world is kept stable, and promoting flexible running of the virtual world.

The foregoing is merely a schematic example. This is not limited in the embodiments of this disclosure.

In conclusion, by converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

In this embodiment of this disclosure, two forms in which the virtual event is implemented as a unidirectional transfer event and a spread event are described. When the virtual event is a unidirectional transfer event, a virtual event is generated by using a first virtual element in a computing period, and the virtual event is applied to a second virtual element in a next computing period, so that a process of applying the virtual event to the virtual element is implemented by changing the second virtual element. When the virtual event is a spread event, a plurality of pieces of event sub-energy are obtained after the event energy is broadcast, and the third virtual element having an action situation is determined according to location components corresponding to different event sub-energy and element location components corresponding to other virtual elements, so as to apply the third event sub-energy to the third virtual element. By means of two forms of unidirectional transfer event and spread event, an action situation of a virtual event is analyzed more comprehensively, thereby improving efficiency of applying the virtual event to a virtual element, and avoiding a problem that the virtual event cannot be accurately applied to the virtual element.

In an embodiment, a virtual element and a virtual event are continuously transformed and acted on in the virtual world, same as a relationship between energy and material in the physical world. In most cases, the virtual element and the virtual event continuously interact in a zone server or a computing unit, and are handed over to the zone server only when the virtual element or the virtual event crosses computing units. When zone servers are crossed, processing is performed by using a logical relationship between the zone servers.

In some aspects, a process of converting a virtual element into a virtual event and finally applying the virtual event to the virtual element may include the following parts.

### (I) A Virtual Element Generating a Virtual Event

In some aspects, a virtual event needs to be used as a medium when a virtual element intends to interact with another virtual element. Most virtual events in a game are generated by virtual elements, and the virtual event is not generated without foundation.

In some embodiments, the virtual element generating the virtual event may be an element placed in a game world, for example, an article, an NPC, or a virtual object controlled by a player. That is, all virtual events have a determined source and do not occur out of thin air.

In some embodiments, generation of a virtual event needs to be performed at a cost of consuming element energy (because the virtual element is implemented in a physical form, the virtual element corresponds to element mass, and the element mass may be referred to as element energy for consumption). After generating a virtual event, the virtual element has reduced element mass or attribute of element energy carried by the virtual element. This is similar to conservation of mass energy in physics. In addition, different types of virtual events require different element energy or element mass, and when the element mass or the element energy is insufficient, a virtual event can no longer be generated.

Based on this, the rule that virtual elements correspond to limited element energy or element mass restricts the generation frequency of virtual events, thereby preventing the problem of overload computing in the virtual world caused by unlimited generation of virtual events. Under this rule, a specific value of consumption of element mass or element energy may be adjusted by a game developer, and different virtual worlds are created according to different parameters.

In some embodiments, event information and event energy carried in a virtual event are computed at a generated moment and are recorded in what component corresponding to the virtual event. In addition, what component further records an event identifier of the virtual event. The event ID identifier is formed based on a zone server (which) in which the virtual event is generated, a moment (when) at which the virtual event is generated, a location (where) in the zone server, and an element identifier of a virtual element generating the virtual event.

In some embodiments, if it is specified that one virtual element can only transmit one virtual event at most in one computing period, an event ID corresponding to the virtual event has global uniqueness.

### (II) Propagation and Operation of a Virtual Event in a Computing Unit

In some aspects, the virtual event carries event information and has event energy. Once the virtual event is generated, the virtual event is always in a propagation state and does not stop until being applied to the virtual element, the zone server, or the computing unit. For example, the query event of the main control virtual object is immediately received and processed by the NPC. Conversely, if the main control virtual object does not approach the front of the NPC but instead aimlessly issues a query, there is a high probability that the NPC will not respond.

In some embodiments, when the virtual event is implemented as a unidirectional transfer event, as shown in FIG. 11, when the virtual event is implemented as a spread event, as shown in FIG. 12.

### (III) Application of a Virtual Event to a Virtual Element

In some embodiments, when a virtual event is applied to the second virtual element, as shown in FIG. 9, details are not described herein again.

### (IV) Interaction Between Virtual Events

In some embodiments, virtual events may overlap and interfere like light, and virtual events in the computing unit also interact with each other according to a superposition and interference rule.

As shown in FIG. 13, a virtual event 1310 transmitted by a main control virtual object is implemented as a spread event. Energy of the virtual event is dispersed, thereby becoming a plurality of sub-events. Different sub-events correspond to sub-event energy, for example, a sub-event 1311 and a sub-event 1312.

For example, the server deploying the virtual world further runs a signal collector. When the signal collector captures a large quantity of sub-events, the captured sub-events are aggregated. If a sum of sub-event energy respectively corresponding to the sub-events may still be superposed to exceed a response threshold of the NPC, the NPC may be affected.

Similar to a case in which only coherent light sources interfere, only virtual events with the same event ID can interact with each other in the computing unit, and a condition that where component and when component are equal needs to be satisfied at the same time.

In addition, a sub-event meeting the interaction condition and the sub-event complete interaction within one computing period of the computing unit, energy of the sub-events are superposed, and event information corresponding to the sub-events remains unchanged. For example, each sub-event corresponds to complete event information. (V) Evolution of a virtual element in a virtual world

In some aspects, all virtual elements in a virtual world are changing. Similar to how all objects are in perpetual motion within the four-dimensional space-time of relativity, even if an object's spatial coordinates remain fixed in a reference system, its temporal coordinates continuously evolve in the space-time diagram.

In some embodiments, an example in which an evolution situation between virtual elements is analyzed in a computing unit is used. Because virtual elements located in different computing units are located at different locations, the virtual elements cannot interact with each other according to a relativity principle. Virtual elements located in a same computing unit cannot be located in the same space-time coordinates. Therefore, the virtual elements cannot directly interact with each other, and a virtual event needs to be used as a medium for action between two virtual elements.

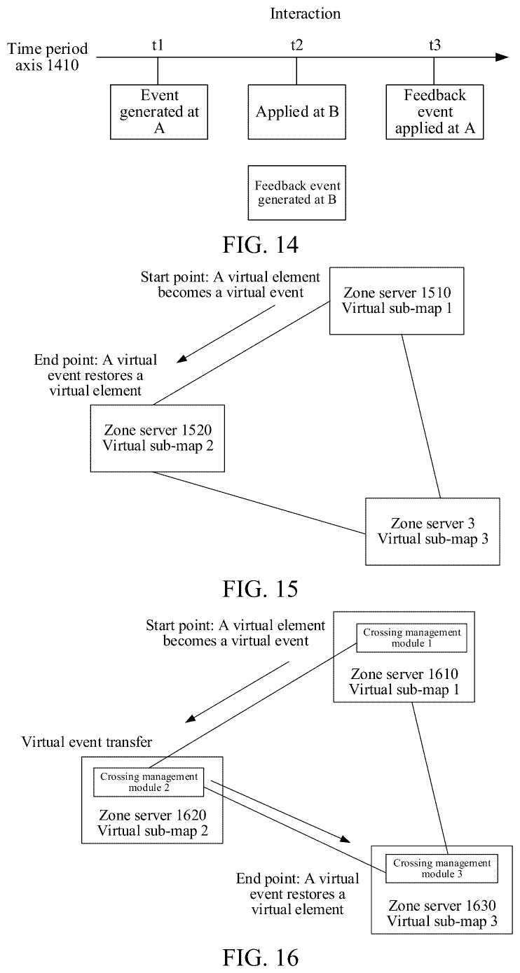

FIG. 14 shows a procedure of interaction between virtual elements in the same computing unit.
(1) A time period axis 1410 is a time meter scale of a clock corresponding to a zone server where a first virtual element and a second virtual element are located, and includes a moment t1, a moment t2, and a moment t3. A first virtual element generates a directional virtual event at A at the moment t1. The virtual event is configured to be applied to a second virtual element at B at the moment t2. A feedback event is also generated at B at the moment t2. Further, the feedback event is applied to A at the moment t3.
(2) The virtual event operates with the second virtual element at the space-time coordinates of the second virtual element in a next computing period to obtain an influence result.
(3) If a new virtual event fed back to the first virtual element is generated in the influence result in (2), in a next computing period, the new virtual event performs an operation on the first virtual element at the space-time coordinates of the first virtual element, to obtain a feedback result.

### (VI) Mutual Conversion Between a Virtual Element and a Virtual Event

In some embodiments, only when a virtual element is converted into a virtual event, the virtual element can cross zone servers or computing units.

As shown in FIG. 15, FIG. 15 is a schematic diagram of taking off and landing of a virtual event at an intersection point of a map boundary corresponding to a virtual world and the virtual event when the virtual event crosses zone servers.

In some aspects, not all locations allow virtual elements to be converted into virtual events to prepare for crossing zone servers. Taking a source zone server (zone server before virtual event crossing) implemented as a zone server 1510 and a target zone server (zone server after virtual event crossing) implemented as a zone server 1520 as an example, the process for converting virtual events into virtual elements is implemented as the following operations.
(1) A virtual element needs to be first moved to a particular boundary of a virtual sub-map (a map corresponding to a sub-virtual world) in the zone server 1510, and these locations may be converted from virtual elements to virtual events. That is, at a particular location, a process of converting a virtual element into a virtual event may be implemented, and the particular location is usually located at a boundary of a virtual sub-map. In some embodiments, the particular location may alternatively be implemented as another particular point or particular region on the virtual sub-map. This is not limited in this embodiment of this disclosure.
(2) When the virtual element is converted into a virtual event, all what components of the virtual element are recorded in what components of the virtual event, and a rule for generating the event ID of the virtual event is the same as a rule for generating the virtual event by the virtual element.
(3) Event energy carried in the virtual event converted into the virtual element is derived from some or all of element energy carried in the element, and an energy value in what component of the virtual element after the conversion is correspondingly reduced.
(4) In some aspects, in a scenario of crossing services, an objective of converting a virtual element into a virtual event is to cross the zone server 1510 and move to another zone server (for example, the zone server 1520). Therefore, the virtual event converted from the virtual element is implemented as a directional event. In a following computing period, the generated virtual event starts to cross a current zone server to move to another zone server indicated by the directional event.

In some embodiments, in a scenario in which different computing units in the same zone servers are crossed, the virtual event generated by the virtual element is also implemented as a directional event, and the generated virtual event starts to cross a current computing unit to move to another computing unit indicated by the directional event.
(5) When the virtual event crosses zone servers or computing units, information about a crossed boundary is recorded, and the crossed boundary becomes a part of a crossing track. In addition, the energy reduced based on the crossing is kept in the computing unit before the crossing or the zone server before the crossing.

In some embodiments, using an example in which the virtual event crosses a start zone server to a zone server after the crossing, a process in which the virtual event is reversely applied to the virtual element is as follows.
(1) The virtual event is received by a termination zone server, and occurs at a particular boundary of a virtual sub-map corresponding to the termination zone server, that is, a location at which the virtual event crosses to the termination zone server.
(2) The virtual event restores what component of the virtual element from what component as what component of the virtual element, where what component is coordinates of the particular boundary, and the element ID of the virtual element remains unchanged. That is, all element attributes of the virtual element in the start zone server are inherited to the virtual element generated in the termination zone server.
(3) The crossing process causes energy of the virtual element to decrease, but a property of the virtual element remains unchanged. Therefore, a game developer may adjust an energy value consumed by a virtual element, to create different game experience.

The foregoing content describes a process in which the virtual element crosses a start zone server to a termination zone server in a single-time crossing manner. The virtual element needs to move to another crossing start point and another crossing end point on the virtual map to continue next crossing.

In an embodiment, the virtual element may sequentially cross a plurality of zone servers in a continuous crossing manner. In some aspects, as shown in FIG. 16, it is a schematic diagram showing that a virtual element continuously crosses a middle zone server for a plurality of times until reaching a termination zone server.

In some aspects, considering that within a zone server (or within a computing unit) there exists the characteristic of being “at the same time but not at the same location”, and because relativistic effects cannot be neglected, the movement process of virtual elements within the intermediate zone server after their arrival cannot be completed instantaneously.

For example, a start zone server is a zone server 1610, a middle zone server is a zone server 1620, and a termination zone server is a zone server 1630. After a virtual event is generated from the zone server 1610, after the virtual event ends a particular point indicated by the zone server 1610, the virtual event crosses to the zone server 1620. A particular point 1 of the zone server 1620 is configured for receiving the virtual event transmitted from the zone server 1610. Only a particular point 2 of the zone server 1620 is configured for transmitting the virtual event to the zone server 1630. Therefore, if the virtual event needs to be crossed from the zone server 1620 to the zone server 1630, the virtual event needs to be transmitted to the zone server 1630 only when the virtual event ends the particular point 2 of the zone server 1620.

In some embodiments, based on the complexity of the foregoing process, when continuous zone server crossing is implemented, a virtual event is not transmitted to a particular point of a virtual sub-map corresponding to a zone server, but is directly handed over to a crossing management module in the zone server.

The crossing management module is configured to manage a continuous crossing process.

In some aspects, the crossing management module in the zone server performs energy deduction on the virtual event, and continues to transmit the virtual event to a next specified zone server. The crossing management module selects corresponding crossing start and end points to reconvert the virtual event into a virtual element until a crossing end condition is satisfied.

There exists no fundamental conflict between the two aforementioned solutions; rather, they constitute two selective modalities under the running method of the virtual world, which can coexist to thereby provide expanded playability possibilities for the virtual world.

In some aspects, a crossing management module is set in a zone server. When the virtual event crosses the zone server, a single-time crossing process is implemented, and the crossing management module is not started, and a transmission process of the virtual event is implemented in a manner of triggering the virtual event at a particular point in the virtual map. The crossing management module starts only when the virtual event is implemented as a continuous crossing process when the virtual event crosses the zone server, so as to implement a process of transferring the virtual event by using the crossing management module. Alternatively, a crossing management module is set in a zone server, and no matter whether the virtual event is implemented as a single-time crossing process or a continuous crossing process when crossing the zone server, a transmission process of the virtual event is implemented by using the crossing management module. Alternatively, regardless of whether the virtual event is implemented as a single-time crossing process or a continuous crossing process when crossing the zone server, a virtual event transfer process or the like is implemented in a manner of triggering the virtual event at a particular point in the virtual map.

The foregoing is merely a schematic example. This is not limited in the embodiments of this disclosure.

In conclusion, by converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

In this embodiment of this disclosure, a virtual world is limited by using an energy consumption rule, so that a player value and an environment value in the virtual world can be effectively balanced, and problems such as value imbalance and contradictions between previous and following settings in a related game can be avoided to a large extent. Under this limitation, computing power consumption of running a virtual world is controlled, and stability of a game is better.

FIG. 17 is a structural block diagram of a running apparatus for a virtual world according to an embodiment of this disclosure. The apparatus includes the following modules:
a receiving module 1710, configured to receive an event generation instruction for a first virtual element, the event generation instruction being configured for consuming first element energy of the first virtual element and generating a virtual event, the first virtual element being an element forming the virtual world, the virtual event being an event unit running in the virtual world, and a virtual element in the virtual world implementing energy interaction through the virtual event;
a consumption module 1720, configured to consume, based on the event generation instruction, element sub-energy that is in the first element energy and that is required for completing the virtual event; and
a generation module 1730, configured to generate the virtual event based on the element sub-energy.

In an embodiment, the consumption module 1720 is further configured to determine an event type based on the event generation instruction, the event type being configured for representing a type of the virtual event instructed to be generated by the event generation instruction; and consume, in response to that the event type is a first event type, first sub-energy that is in the first element energy and that is required for completing the virtual event, the first event type being configured for consuming the first sub-energy, and the first sub-energy being configured for representing a first amount of element sub-energy.

In an embodiment, the consumption module 1720 is further configured to consume, in response to that the event type is a second event type, second sub-energy that is in the first element energy and that is required for completing the virtual event, the second event type being configured for consuming the second sub-energy, the second sub-energy being configured for representing a second amount of element sub-energy, and the second event type being different from the first event type.

In an embodiment, the generation module 1730 is further configured to generate the virtual event from the element sub-energy consumed by the first virtual element; or determine event energy corresponding to the virtual event, the event energy being less than the element sub-energy; and generate the virtual event by using a difference between the element sub-energy and the event energy as event pushing energy, the event pushing energy being configured for generating the virtual event.

In an embodiment, the virtual event is implemented as at least two virtual sub-events.

The generation module 1730 is further configured to determine required energy respectively required for generating the at least two virtual sub-events, the at least two required energy forming the element sub-energy; allocate the element sub-energy based on the required energy respectively corresponding to the at least two virtual sub-events, to obtain an allocation result, the allocation result being configured for representing a numerical result of the sub-energy allocated to the virtual sub-event; and generate the at least two virtual sub-events based on the allocation result.

In an embodiment, a server configured for deploying the virtual world includes a plurality of zone servers, and the plurality of zone servers are respectively configured for managing at least one virtual element; and
the generation module 1730 is further configured to generate, in response to that the first virtual element targeted by the event generation instruction is managed by a first zone server in the plurality of zone servers, the virtual event in the first zone server.

In an embodiment, at least one zone server of the plurality of zone servers includes a plurality of computing units, and the computing unit is configured to manage at least one virtual element in the zone server; and
the generation module 1730 is further configured to generate, in response to that the first virtual element targeted by the event generation instruction is managed by a first computing unit in the plurality of computing units, the virtual event in the first computing unit.

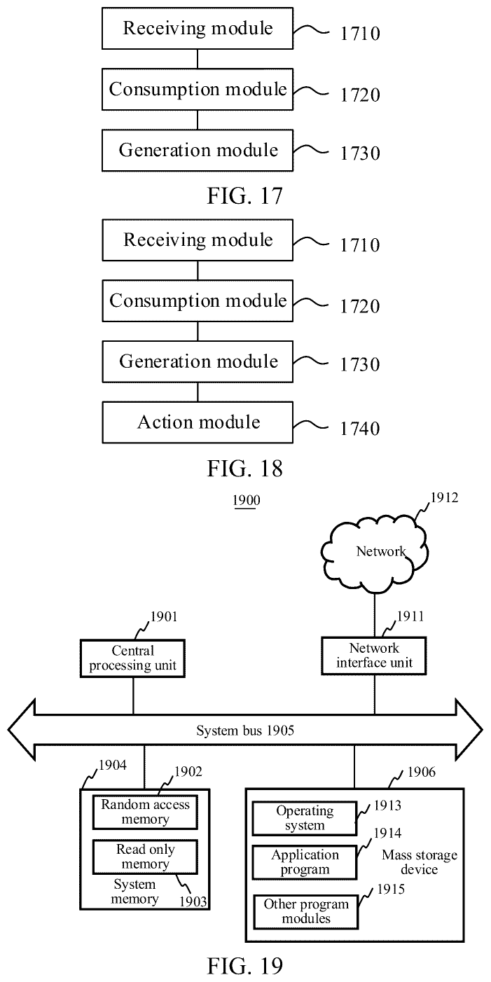

As shown in FIG. 18, in an embodiment, the virtual event includes a unidirectional transfer event, and the unidirectional transfer event is an event having a single propagation direction.

The apparatus further includes:
an action module 1740, configured to determine a second virtual element targeted by the virtual event, the second virtual element being configured for representing a virtual element receiving the virtual event; and apply event energy corresponding to the virtual event to the second virtual element, the event energy being energy obtained based on conversion of the element sub-energy.

In an embodiment, the action module 1740 is further configured to: apply the event energy to the second virtual element in response to that the event energy corresponding to the virtual event reaches a preset trigger threshold for triggering the second virtual element, the preset trigger threshold being a threshold condition for triggering the second virtual element to receive the event energy.

In an embodiment, the second virtual element corresponds to second element energy before being acted on by the virtual event; and
the action module 1740 is further configured to convert the event energy corresponding to the virtual event into element energy of the second virtual element, to obtain the second virtual element with third element energy, the third element energy being a sum of the event energy and the second element energy; or determine first event sub-energy consumed in a process in which the virtual event reaches the second virtual element, the first event sub-energy being less than the event energy; determine a difference between the event energy and the first event sub-energy, to obtain second event sub-energy; and convert the second event sub-energy into element energy of the second virtual element, to obtain the second virtual element with fourth element energy, the fourth element energy being a sum of the second event sub-energy and the second element energy.

In an embodiment, the server configured for deploying the virtual world includes a plurality of zone servers, and the plurality of zone servers are respectively configured for managing at least one virtual element;
the virtual element is represented by using an element vector, and the element vector is formed by at least one of an element attribute component, an element zone server component, an element location component, and an element moment component; the element attribute component is configured for representing an element attribute of the virtual element, the element zone server component is configured for representing a zone server in which the virtual element is located, the element location component is configured for representing location information of the virtual element in the zone server in which the virtual element is located, and the element moment component is configured for representing time information of the virtual element in the zone server in which the virtual element is located;
the virtual event is represented by using an event vector, and the event vector is formed by at least one of an event attribute component, an event zone server component, an event location component, and an event moment component; and the event attribute component is configured for representing an event attribute of the virtual event, the event zone server component is configured for representing a zone server in which the virtual event is located, the event location component is configured for representing location information of the virtual event in the zone server in which the virtual event is located, and the event moment component is configured for representing time information of the virtual event in the zone server in which the virtual event is located.

In an embodiment, the element vector includes an element location component and an element moment component, and the event vector includes an event location component and an event moment component; and
the action module 1740 is further configured to: determine an event location component and an event moment component corresponding to the virtual event and determining an element location component and an element moment component corresponding to the second virtual element in response to that the first virtual element and the second virtual element are both managed by the first zone server in the plurality of zone servers; and apply the event energy corresponding to the virtual event to the second virtual element in response to that the event location component is the same as the element location component, and the event moment component is the same as the element moment component.

In an embodiment, the element attribute component includes element energy corresponding to the virtual element, and the event attribute component includes event energy corresponding to the virtual event; and
the action module 1740 is further configured to adjust an element attribute component of the second virtual element by using the event energy corresponding to the virtual event; or adjust an element location component of the second virtual element by using the event energy corresponding to the virtual event.

In an embodiment, the virtual event includes a spread event; and
the action module 1740 is further configured to broadcast the event energy corresponding to the virtual event, to obtain a plurality of pieces of event sub-energy, the plurality of pieces of event sub-energy correspond to different location components; and apply, in response to that a third virtual element exists at a location indicated by a location component of third event sub-energy, the third event sub-energy to the third virtual element, the third event sub-energy being event sub-energy in the plurality of pieces of event sub-energy.

In an embodiment, the generation module 1730 is further configured to determine, based on the event generation instruction, an energy requirement value required for completing the virtual event; consume, in response to that the energy requirement value is not greater than the first element energy, the element sub-energy that is in the first element energy and that is required for completing the virtual event; and stop, in response to that the energy requirement value is greater than the first element energy, consuming the first element energy based on the event generation instruction.

In an embodiment, the receiving module 1710 is further configured to receive the event generation instruction transmitted by a terminal, the event generation instruction being an instruction generated by the terminal based on a received event generation operation; and the event generation operation is configured for triggering the first virtual element.

In conclusion, by converting element energy of a virtual element into energy required for generating a virtual event, conservation of energy in a virtual world can be kept, thereby avoiding problems of complex processing of various events by only a server and a large quantity of processing times. By means of energy maintenance and conversion processes of the virtual world, game reality is improved, and a problem of data processing inefficiency is reduced, thereby greatly improving game stability.

The running apparatus for a virtual world provided in the foregoing embodiments is illustrated with an example of division of the foregoing functional modules. In actual application, the functions may be allocated to and completed by different functional modules according to requirements, that is, the internal structure of the device is divided into different functional modules, to implement all or some of the functions described above. In addition, the running apparatus for a virtual world provided in the foregoing embodiment belongs to the same concept as the running method embodiment for a virtual world. For a specific implementation process thereof, refer to the method embodiment, and details are not described herein again.

FIG. 19 is a schematic structural diagram of a server according to an embodiment of this disclosure. In some examples, the following structure is included.

A server 1900 includes a central processing unit (CPU) 1901, a system memory 1904 including a random access memory (RAM) 1902 and a read only memory (ROM) 1903, and a system bus 1905 connecting the system memory 1904 to the CPU 1901. The server 1900 further includes a large-capacity storage device 1906 configured to store an operating system 1913, an application program 1914, and another program module 1915.

The mass storage device 1906 is connected to the CPU 1901 by using a mass storage controller (not shown) connected to the system bus 1905.

Generally, the computer-readable medium may include a computer storage medium and a communication medium. According to the embodiments of this disclosure, the server 1900 may further be connected, through a network such as the Internet, to a remote computer on the network and run. That is, the server 1900 may be connected to a network 1912 by using a network interface unit 1911 that is connected to the system bus 1905, or may be connected to a network of another type or a remote computer system (not shown) by using the network interface unit 1911.

The foregoing memory further includes one or more programs. The one or more programs are stored in the memory and are configured to be executed by the CPU.

An embodiment of this disclosure further provides a computer device, including a processor and a memory, the memory having at least one instruction, at least one segment of program, and a code set or an instruction set stored therein, the at least one instruction, the at least one segment of program, and the code set or the instruction set being loaded and executed by the processor to implement the running method for a virtual world provided in the foregoing method embodiments. In some embodiments, the computer device may be a terminal, or may be a server.

An embodiment of this disclosure further provides a computer-readable storage medium is provided, having at least one instruction, at least one segment of program, a code set, or an instruction set stored therein, and the at least one instruction, at least one segment of program, code set, or instruction set being loaded and executed by a processor to implement the running method for a virtual world provided in the foregoing method embodiments.

An embodiment of this disclosure provides a computer program product or a computer program. The computer program product or the computer program includes computer instructions, and the computer instructions are stored in a computer-readable storage medium. A processor of a computer device reads the computer instructions from the computer-readable storage medium and executes the computer instructions, to enable the computer device to perform the running method for a virtual world according to any one of the foregoing embodiments.

In some embodiments, the computer-readable storage medium may include: a read only memory (ROM), a random access memory (RAM), a solid state drive (SSD), an optical disc, and the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like. The foregoing descriptions are merely embodiments of this disclosure, but are not intended to limit this disclosure. Any modification, equivalent replacement, or improvement made within the spirit and principle of this disclosure shall fall within the protection scope of this disclosure.

What is claimed is:

1. A method for running a virtual world in a virtual scene application, the method comprising:
receiving an event generation instruction, the event generation instruction instructing a generation of a first virtual event by a first virtual element with a consumption of at least a portion of first element energy of the first virtual element, the first virtual element being one of a plurality of virtual elements that form the virtual world, and the plurality of virtual elements in the virtual world implementing energy interaction through virtual events;
consuming, based on the event generation instruction, element sub-energy from the first element energy of the first virtual element, the element sub-energy being used for completing the first virtual event; and
generating the first virtual event based on the consuming of the element sub-energy from the first element energy of the first virtual element.

2. The method according to claim 1, wherein the consuming comprises:
determining an event type of the first virtual event based on the event generation instruction; and
consuming, when the event type is a first event type, first sub-energy from the first element energy, the first sub-energy representing a first amount of the element sub-energy for the first event type.

3. The method according to claim 2, wherein the method further comprises:
consuming, when the event type is a second event type, second sub-energy from the first element energy, the second sub-energy representing a second amount of the element sub-energy for the second event type, and the second event type being different from the first event type.

4. The method according to claim 1, wherein the generating comprises:
determining an event energy that is carried with the first virtual event, the event energy being less than the element sub-energy for the consuming; and
generating the first virtual event by using a difference between the element sub-energy and the event energy as an event pushing energy, the event pushing energy being depleted for the generating the first virtual event.

5. The method according to claim 1, wherein:
the first virtual event is implemented as at least two virtual sub-events; and
the generating the first virtual event comprises:
determining respective energy requirements for generating the at least two virtual sub-events;
allocating the element sub-energy based on the respective energy requirements to obtain an allocation result, the allocation result representing numerical results of allocations of the element sub-energy to the at least two virtual sub-events; and
generating the at least two virtual sub-events based on the allocation result.

6. The method according to claim 1, wherein:
the virtual world is deployed by a plurality of zone servers, and the plurality of zone servers are respectively configured for managing at least one virtual element; and
the method further comprises:
generating, when the first virtual element is managed by a first zone server in the plurality of zone servers, the first virtual event in the first zone server.

7. The method according to claim 6, wherein:
the first zone server comprises a plurality of computing units that are configured to manage at least one virtual element in the first zone server; and
the method further comprises:
generating, when the first virtual element is managed by a first computing unit in the plurality of computing units, the first virtual event in the first computing unit.

8. The method according to claim 1, wherein:
the first virtual event comprises a unidirectional transfer event having a single propagation direction from the first virtual element to another virtual element; and
the method further comprises:
determining a second virtual element that receives the first virtual event; and
applying an event energy that is carried with the first virtual event to the second virtual element, the event energy being obtained based on a conversion of the element sub-energy.

9. The method according to claim 8, wherein the applying comprises:
applying the event energy to the second virtual element when the event energy that is carried with the first virtual event reaches a preset trigger threshold for triggering the second virtual element, the preset trigger threshold being a threshold condition for triggering the second virtual element to receive the event energy.

10. The method according to claim 8, wherein:
the second virtual element has second element energy before the event energy is applied; and
the applying comprises:
converting the event energy that is carried with the first virtual event into additional element energy of the second virtual element, to obtain third element energy of the second virtual element, the third element energy being a sum of the event energy and the second element energy.

11. The method according to claim 8, wherein:
the second virtual element has second element energy before the event energy is applied; and
the applying comprises:
determining first event sub-energy that is depleted from the first virtual event in a propagation process from the first virtual element to the second virtual element, the first event sub-energy being less than the event energy;
determining a difference between the event energy and the first event sub-energy, to obtain second event sub-energy; and
converting the second event sub-energy into additional element energy of the second virtual element, to obtain fourth element energy of the second virtual element, the fourth element energy being a sum of the second event sub-energy and the second element energy.

12. The method according to claim 8, wherein:
the virtual world is deployed by a plurality of zone servers;
the plurality of zone servers are respectively configured for managing at least one virtual element;
a virtual element managed by a zone server is represented by using an element vector that comprises at least one of an element attribute component, an element zone server component, an element location component, and an element moment component;
the element attribute component representing an element attribute of the virtual element,
the element zone server component representing the zone server,
the element location component representing location information of the virtual element in the zone server, and
the element moment component representing time information of the virtual element in the zone server; and
the first virtual event is represented by using an event vector that comprises at least one of an event attribute component, an event zone server component, an event location component, and an event moment component;
the event attribute component representing an event attribute of the first virtual event,
the event zone server component representing a zone server in which the first virtual event is located,
the event location component representing location information of the first virtual event in the zone server, and
the event moment component representing time information of the first virtual event in the zone server.

13. The method according to claim 12, wherein:
the element vector comprises the element location component and the element moment component, and the event vector comprises the event location component and the event moment component; and
the applying comprises:
determining a first event location component and a first event moment component of the first virtual event;
determining a first element location component and a first element moment component of the second virtual element when the first virtual element and the second virtual element are both managed by a first zone server in the plurality of zone servers; and
applying the event energy that is carried with the first virtual event to the second virtual element when the first event location component is the same as the first element location component, and the first event moment component is the same as the first element moment component.

14. The method according to claim 12, wherein:
the element attribute component comprises element energy of the virtual element;
the event attribute component comprises the event energy of the first virtual event; and
the applying comprises at least one of:
adjusting an element attribute component of the second virtual element by using the event energy corresponding to the first virtual event; or
adjusting an element location component of the second virtual element by using the event energy corresponding to the first virtual event.

15. The method according to claim 1, wherein:
the first virtual event comprises a spread event; and
the method further comprises:
broadcasting event energy of the first virtual event, to obtain a plurality of pieces of event sub-energy that correspond to different location components of the event energy at different locations; and
applying, when a third virtual element exists at a location in the different locations, third event sub-energy to the third virtual element, the third event sub-energy being a location component of the different location components at the location.

16. The method according to claim 1, wherein the method further comprises:
determining, based on the event generation instruction, an energy requirement value for completing the first virtual event;
consuming, when the energy requirement value is not greater than the first element energy, the element sub-energy that is in the first element energy and that is required for completing the first virtual event; and
stopping, when the energy requirement value is greater than the first element energy, consuming the first element energy based on the event generation instruction.

17. The method according to claim 1, wherein the receiving comprises:
receiving the event generation instruction transmitted by a terminal device, the event generation instruction being an instruction generated by the terminal device based on a received event generation operation; and
the received event generation operation being configured for triggering the first virtual element.

18. An apparatus for running a virtual world in a virtual scene application, comprising processing circuitry configured to:
receive an event generation instruction, the event generation instruction instructing a generation of a first virtual event by a first virtual element with a consumption of at least a portion of first element energy of the first virtual element, the first virtual element being one of a plurality of virtual elements that form the virtual world, and the plurality of virtual elements in the virtual world implementing energy interaction through virtual events;
consume, based on the event generation instruction, element sub-energy from the first element energy, the element sub-energy being used for completing the first virtual event; and
generate the first virtual event based on the consuming of the element sub-energy from the first element energy of the first virtual element.

19. The apparatus according to claim 18, wherein the processing circuitry is configured to:
determine an event energy that is carried with the first virtual event, the event energy being less than the element sub-energy for the consuming; and
generate the first virtual event by using a difference between the element sub-energy and the event energy as an event pushing energy, the event pushing energy being depleted for the generating the first virtual event.

20. A non-transitory computer-readable storage medium storing instructions which when executed by at least one processor cause the at least one processor to perform:
receiving an event generation instruction, the event generation instruction instructing a generation of a first virtual event by a first virtual element with a consumption of at least a portion of first element energy of the first virtual element, the first virtual element being one of a plurality of virtual elements that form a virtual world in a virtual scene application, and the plurality of virtual elements in the virtual world implementing energy interaction through virtual events;
consuming, based on the event generation instruction, element sub-energy from the first element energy, the element sub-energy being used for completing the first virtual event; and
generating the first virtual event based on the consuming of the element sub-energy from the first element energy of the first virtual element.
